(19) United States
(12) Patent Application Publication
(10) Pub. No.: US 2026/0368992 A1
(43) Pub. Date: Nov. 19, 2026

(54) 3D OBJECT ATTRIBUTE AND WEBTOON-BASED IMAGE GENERATING DEVICE AND METHOD THEREOF

(71) Applicant: TOONSQUARE CORP, Seoul (KR)

(72) Inventors: Ho Young LEE, Seoul (KR); Gyu Cheol KIM, Seocho-gu (KR); Hosup CHOI, Uiwang-si (KR); Gi Young SHIN, Namdong-gu (KR); Won Joong KIM, Suwon-si (KR); Hyun Young HWANG, Gwonseon-gu (KR); Jong Ho SONG, Seocho-gu (KR); Yeon Jae SUNG, Nowon-gu (KR); Dong Won AHN, Dongjak-gu (KR); Dongjun KIM, Yongsan-gu (KR)

(73) Assignee: TOONSQUARE CORP, Seoul (KR)

(21) Appl. No.: 19/306,338

(22) Filed: Aug. 21, 2025

Related U.S. Application Data
(63) Continuation of application No. PCT/KR2025/008593, filed on Jun. 20, 2025.

(30) Foreign Application Priority Data
May 19, 2025 (KR) 10-2025-0064603
May 19, 2025 (KR) 10-2025-0064616

(51) Int. Cl. G06T 15/02

(52) U.S. Cl. CPC G06T 15/02

(57) ABSTRACT

Disclosed are an image generating device based on a 3D object attribute and a webtoon, and a method thereof. The image generating device accurately and consistently reflects user-specified attribute values to results of a generative AI when generating a 3D object-based image, automatically extract content information of a cut unit based on story text when generating a webtoon-based image, automatically generates a plurality of cut images by using artificial intelligence based on the corresponding information, automatically configure a multi-cut layout based on the generated cut images and content metadata, and alternatively generates and selects each cut image by the user.

### CROSS-REFERENCE TO RELATED APPLICATIONS

The present application is a continuation of International Patent Application No. PCT/KR2025/008593 filed on Jun. 20, 2025, which is based upon and claims the benefit of priority to Korean Patent Application No. 10-2025-0064603 filed on May 19, 2025 and 10-2025-0064616 filed on May 19, 2025. The disclosures of the above-listed applications are hereby incorporated by reference herein in their entirety.

### BACKGROUND

Embodiments of the present disclosure described herein relate to an image generating device and a method thereof, and more particularly, relate to an image generating device for precisely controlling image output of generative artificial intelligence based on an attribute value of a 3D object and generating a multi-cut image in the form of a webtoon, and a method thereof.

Conventional generative AI-based image generation technologies may generate image results based on prompts entered by users, and thus may have certain limitations in accuracy and consistency. In particular, even when a user specifies a specific attribute value (e.g., hair color, facial expression, clothing, etc.), the generated image may not accurately reflect the corresponding attribute, or results may not satisfy the user's needs due to a lack of visual consistency between the results.

These issues may be especially evident in content creation environments where a 2D image is converted to a 3D object, or a plurality images need to be created under a consistent concept. Moreover, because the conventional technology does not consider the overall composition, angle, or distance of an image, the intensity and visibility of expression between output images appear different. For example, in a close-up shot, a ‘smile expression’ is clearly expressed, but in a full shot, even when the same attribute value is applied, the expression is barely visible, thereby making it difficult to implement the expressive effect intended by a user.

To solve the issues, there is a growing need for a technology that operates independently of a prompt, individually specifies attribute values of 3D objects, and automatically reflects or corrects these attribute values in the prompt.

Furthermore, to conventionally produce webtoons, storyboards, or digital comic content, after writing the story, a writer or producer needs to manually divide cuts depending on the flow of each scene, and individually set visual elements such as characters, backgrounds, and objects that may appear in each cut. Accordingly, most of works such as image creation or arrangement, speech bubble creation, and effect text insertion are also done manually.

In particular, attempts to automatically generate images or video content by using generative AI have been spreading recently. However, the generative AI simply generates a single image or non-sequential visual elements depending on a given prompt, and thus has limitations in automating the composition of cut-unit images that reflect the narrative-based story flow. Besides, when the image generated in units of cut does not match the user's intent or requires reconstruction, a process of modifying or replacing the generated image is entirely dependent on manual work, thereby reducing production flexibility and inevitably involving repetitive work. In particular, because the conventional system has a structure that composes prompts based on a single image and outputs results, it is difficult to automatically place images and apply smart layouts in consideration of scene development or connection between cuts according to the flow of a story.

To solve these issues, there is an increasing need for a technology that may automatically generate images and visual elements by using generative AI, while automatically arranging and editing multi-cuts based on metadata of the generated cut images.

### SUMMARY

Embodiments of the present disclosure provide an image generating device that may accurately and consistently reflect user-specified attribute values to results of a generative AI when generating a 3D object-based image, and a method thereof.

Embodiments of the present disclosure provide an image generating device that may maintain consistent visual effects that match the user's intent even in various shooting compositions, by automatically correcting a weight depending on screen occupancy ratio or visual visibility even with the same attribute values in consideration of cut attribute information such as a camera angle, a distance, a location, and a shot type during an image generating process, and a method thereof.

Embodiments of the present disclosure provide an image generating device that may allow the input of attribute values through numeric input or visual selection, may provide a preview of the expected image results depending on the selected attribute values, and automatically may generate a prompt or reflect a corrected weight depending on a user's selection, and a method thereof.

Embodiments of the present disclosure provide an image generating device that may maintain a balance of expression intensity among various objects by adjusting attribute weights depending on the screen occupancy ratio or the relative size of each object when generating an image including a plurality of 3D objects, and a method thereof.

Embodiments of the present disclosure provide an image generating device that may automatically extract content information of a cut unit based on story text, may automatically generate a plurality of cut images by using artificial intelligence based on the corresponding information, may automatically configure a multi-cut layout based on the generated cut images and content metadata, and may alternatively generate and select each cut image by the user, and a method thereof.

Embodiments of the present disclosure provide a device that may produce intuitive and interactive webtoons, by automatically generating speech bubbles and effect text from text information included in each cut, placing them in appropriate locations, generating various alternative image candidates by changing some of the cut components (background, characters, lines, situations, and the like), and reflecting user selection, and a method thereof.

Embodiments of the present disclosure provide a device that may realize automation, efficiency, and personalized expression of a webtoon and visual content producing process by minimizing interference in cut arrangement through a smart layout algorithm in consideration of a cut-to-cut size, spacing, a text location, a viewpoint transition, and providing an interface that allows users to intuitively edit individual cut components or an entire layout, and a method thereof.

Problems to be solved by the present disclosure are not limited to the problems mentioned above, and other problems not mentioned will be apparent by those skilled in the art from the following description.

According to an embodiment, an image generating device includes a display unit that provides an input interface for receiving selection information of at least one 3D object for image generation and attribute value designation information of the 3D object, a memory that stores at least one process related to an operation of generating an image by using the 3D object and a generative AI model, and a processor that performs an operation according to the process. The processor obtains the 3D object selected through the input interface, and an attribute value of the selected 3D object, obtains cut attribute information through the input interface, corrects a weight of the attribute value based on the cut attribute information, generates a prompt based on the 3D object and an attribute value reflecting the corrected weight, and generates a final image by inputting the generated prompt into the generative AI model.

In this case, the processor may generate a temporary prompt based on the 3D object and the attribute value, and may change the temporary prompt to the prompt based on the 3D object and the attribute value reflecting the corrected weight.

Moreover, the cut attribute information may include at least one of a type of shooting shot, a camera angle, a distance between the 3D object and a camera, a location of the 3D object, and an expected screen occupancy ratio occupied by the 3D object in the image.

Furthermore, the processor may correct the weight of the attribute value based on the type of the shooting shot.

Also, the processor may identify the expected screen occupancy ratio that the 3D object occupies in the image, may compare the expected screen occupancy ratio with a preset first threshold value and a preset second threshold value, may perform the correction to increase the weight of the attribute value when the comparison result indicates that the expected screen occupancy ratio is less than the first threshold value, and may perform the correction to decrease the weight of the attribute value when the comparison result indicates that the expected screen occupancy ratio exceeds the second threshold value.

In this case, the attribute value may include at least one of expression intensity, a size or speed of a motion, hair color, clothing color, or sharpness of a pattern of the 3D object.

Besides, the processor may provide a preview of an expected result to which the attribute value is applied, when detecting an input through which a user specifies the attribute value through the input interface.

In addition, the processor may automatically generate an associated prompt and an attribute value corresponding to the visual option when detecting an input through which a user selects a predefined visual option.

According to an embodiment, an image generating device includes a display unit that provides an input interface for obtaining a story, a memory that stores at least one process related to an operation of generating a story image by using the story, and a processor that performs an operation according to the process. The processor obtains the story through the input interface, analyzes the obtained story to split the story into a plurality of cuts, extracts content information based on text included in each of the plurality of cuts, generates a plurality of initial images corresponding to the plurality of cuts based on the extracted content information, generates the pieces of cut-specific metadata based on the content information and the plurality of initial images, generates a multi-cut layout based on the generated pieces of cut-specific metadata and the plurality of initial images, displays the multi-cut layout via the input interface, obtains an image regeneration request for at least one cut image included in the multi-cut layout from a user through the input interface, and generates a plurality of candidate images for the at least one cut image based on metadata of a cut corresponding to the at least one cut image in response to the image regeneration request.

In this case, the processor may display the generated plurality of candidate images through the display unit, may obtain a selection input of a user for one candidate image of the plurality of candidate images through the input interface, and may update the multi-cut layout by replacing the at least one cut image with the selected candidate image.

Moreover, the extracted content information may include at least one of character information, background information, and object information.

Furthermore, the pieces of cut-specific metadata may include at least one of character information, background information, object information, motion information, camera angle information, shooting shot information, time information, situation information, and text information.

Also, the processor may generate a speech bubble and effect text based on the text information included in the pieces of cut-specific metadata, and may place the speech bubble and the effect text on a plurality of cut images included in the multi-cut layout.

Besides, the processor may generate the plurality of candidate images by using at least one of changing, deleting, or adding a component included in the at least one cut image. The component may include at least one of a situation, a character, a background, a camera angle, a shooting shot, a sound effect, and a line.

In addition, the processor may generate the multi-cut layout to minimize interference between cuts in consideration of a special symbol, a punctuation mark, a scene transition keyword, a time transition keyword, a location transition keyword, a size of each cut image, spacing between cuts, and locations of the speech bubble and the effect text, which are included in text of the story.

Moreover, the processor may further provide an editing interface that allows a user to change at least one component of a cut image included in the multi-cut layout or to reconfigure a multi-cut, through the display unit.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram showing a detailed configuration of an image generating device, according to an embodiment of the present disclosure;

FIG. 2 is a flowchart illustrating an image generation method, according to an embodiment of the present disclosure;

FIGS. 3 to 6 are example diagrams showing an image generation method, according to an embodiment of the present disclosure;

FIG. 7 is a flowchart illustrating a weight correcting method based on a shooting shot, according to an embodiment of the present disclosure;

FIGS. 8 and 9 are example diagrams showing a weight correcting method based on a shooting shot, according to an embodiment of the present disclosure;

FIG. 10 is a flowchart illustrating a weight correcting method based on expected screen occupancy ratio, according to an embodiment of the present disclosure;

FIG. 11 is a flowchart illustrating a preview providing method, according to an embodiment of the present disclosure;

FIG. 12 is an example diagram illustrating a preview providing method, according to an embodiment of the present disclosure;

FIG. 13 is a flowchart illustrating a method for preventing attribute value changes and ensuring visual uniformity, according to an embodiment of the present disclosure;

FIG. 14 is a flowchart illustrating an image converting method based on AI painting style, according to an embodiment of the present disclosure;

FIGS. 15 to 19 are example diagrams showing an image converting method based on AI painting style, according to an embodiment of the present disclosure;

FIG. 20 is a flowchart illustrating a method for generating a multi-cut layout, according to an embodiment of the present disclosure;

FIGS. 21 to 23 are example diagrams showing a method for generating a multi-cut layout, according to an embodiment of the present disclosure;

FIG. 24 is a flowchart illustrating a method for updating a multi-cut layout, according to an embodiment of the present disclosure;

FIGS. 25 to 27 are example diagrams showing a method for updating a multi-cut layout, according to an embodiment of the present disclosure;

FIGS. 28 and 29 are example diagrams showing a method for providing an editing interface, according to an embodiment of the present disclosure; and

FIG. 30 is a flowchart showing a method for generating speech bubble and effect text, according to an embodiment of the present disclosure.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, a ‘device according to an embodiment of the present disclosure’ includes all various devices capable of providing results to a user by performing arithmetic processing. For example, the apparatus according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Functions related to artificial intelligence according to an embodiment of the present disclosure are operated through a processor and a memory. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

The predefined operating rule or the artificial intelligence model is created through learning. Here, being created through learning means creating the predefined operating rule or the artificial intelligence model configured to perform desired features (or purposes) as a basic artificial intelligence model is learned by using pieces of learning data by a learning algorithm. This learning may be performed by an apparatus itself, on which the artificial intelligence according to an embodiment of the present disclosure is performed, or may be performed through a separate server and/or system. For example, the learning algorithm may include supervised learning, unsupervised learning, semi-supervised learning, or reinforcement learning, but may not be limited to the above example.

An artificial intelligence model may be composed of a plurality of neural network layers. The plurality of neural network layers respectively have a plurality of weight values, and each of the plurality of neural network layers performs neural network calculation through calculations between the calculation result of the previous layer and the plurality of weight values. The plurality of weight values of the plurality of neural network layers may be optimized by the learning result of the artificial intelligence model. For example, during a learning process, the plurality of weight values may be updated such that a loss value or a cost value obtained from the artificial intelligence model is reduced or minimized. The artificial neural network may include a deep neural network (DNN). The artificial neural network may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the above-described example.

According to an embodiment of the present disclosure, a processor may implement artificial intelligence. The artificial intelligence may refer to an artificial neural network-based machine learning method that allows a machine to perform learning by simulating human biological neurons. The methodology of artificial intelligence may be classified as supervised learning, in which a solution (output data) to a problem (input data) is determined by providing input data and output data together as training data depending on a learning method, unsupervised learning, in which only input data is provided without output data, and thus the solution (output data) to the problem (input data) is not determined, and reinforcement learning, in which a reward is given from an external environment whenever an action is taken in a current state, and thus learning progresses to maximize this reward. Moreover, the methodology of artificial intelligence may also be categorized depending on architecture, which is the structure of the learning model. The architecture of deep learning technology widely used may be categorized into convolutional neural networks (CNN), recurrent neural networks (RNN), transformers, and generative adversarial networks (GAN).

Each of the apparatus and the system may include an artificial intelligence model. The artificial intelligence model may be a single artificial intelligence model or may be implemented as a plurality of artificial intelligence models. The artificial intelligence model may be composed of neural networks (or artificial neural networks) and may include a statistical learning algorithm that mimics biological neurons in machine learning and cognitive science. The neural network may refer to a model as a whole having the ability to solve problems as artificial neurons (nodes), which form a network by connecting synapses, changes the strength of their synaptic connections through learning. Neurons in the neural network may include the combination of weight values or biases. The neural network may include one or more layers consisting of one or more neurons or nodes. For example, the apparatus may include an input layer, a hidden layer, and an output layer. The neural network constituting the apparatus may infer the result (output) to be predicted from an arbitrary input by changing a weight value of a neuron through learning.

The processor may create a neural network, may train or learn a neural network, or may perform operations based on received input data, and then may generate an information signal or may retrain the neural network based on the performed results. Models of a neural network may include various types of models such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) Network, and a classification network, but is not limited thereto. The processor may include one or more processors for performing computations according to the models of the neural network. For example, the neural network may include a deep neural network.

It will be understood by those skilled in the art that a neural network may include any neural network, but is not limited to a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an embodiment of the present disclosure, the processor may use various artificial intelligence structures and algorithms such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) Network, a classification network, Generative Modeling, eXplainable AI, Continual AI, Representation Learning, AI for Material Design, algorithms for natural language processing (e.g., BERT, SP-BERT, MRC/QA, Text Analysis, Dialog System, GPT-3, and GPT-4), algorithms for vision processing (e.g., Visual Analytics, Visual Understanding, Video Synthesis, and ResNet), algorithms for data intelligence (e.g., Anomaly Detection, Prediction, Time-Series Forecasting, Optimization, Recommendation, and Data Creation), but is not limited thereto. Hereinafter, an embodiment of the present disclosure will be described in detail with reference to the accompanying drawings.

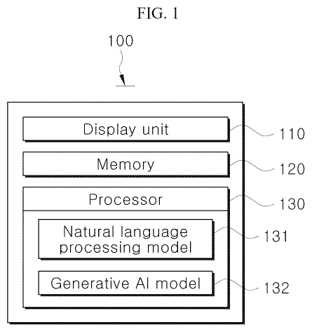

First of all, referring to FIGS. 1 to 19, according to an embodiment of the present disclosure, an image generating device and a method thereof that may precisely control image output of a generative artificial intelligence based on an attribute value of a 3D object will be described in detail.

FIG. 1 is a block diagram showing a detailed configuration of an image generating device, according to an embodiment of the present disclosure.

Referring to FIG. 1, an image generating device 100 according to an embodiment of the present disclosure may generate an image that satisfy a user's intent by specifying a visual attribute value of a 3D object based on the user's input, generating a prompt based on the specified attribute value and cut attribute information, and providing the prompt to a generative AI model. The image generating device 100 may include a display unit 110 that provides a user interface, a memory 120 that stores a processing procedure for generating a prompt and generating an image, and a processor 130 that performs the procedure.

In an embodiment, the display unit 110 may provide an input interface for receiving selection information of at least one 3D object for image generation and attribute value designation information of the 3D object.

For example, the display unit 110 may include a UI module capable of operating in conjunction with various input means such as a touch display, a mouse, a keyboard, and a speech recognition device, and may provide a selection interface for receiving the selection of at least one 3D object from a user, and an attribute value input interface for specifying an attribute value such as an expression, hair color, and a clothing style of the selected 3D object. The display unit 110 may be configured to allow intuitive specification of attribute values of a user by including example images, color charts, sliders (weight adjustment bars), or predefined option lists corresponding to each attribute such that the user may visually identify the attribute values set by the user.

Moreover, the display unit 110 may help predict the result by generating and displaying a preview image in real time based on the attribute value and cut attribute information entered by the user. In this case, the cut attribute information may include information corresponding to shooting conditions such as a relative location of a 3D object within an image frame, a ratio of the occupied area, an camera angle (e.g., a high angle or a low angle), a shot type (e.g., close-up or full shot), and a distance between a camera and a subject.

For example, the display unit 110 displays (outputs) information processed by the present device. For example, the display unit 110 may display execution screen information of an application running on the present device, or a user interface (UI) or graphical user interface (GUI) information according to the execution screen information.

In an embodiment, the memory 120 may store at least one process related to an operation of generating an image by using the 3D object and the generative AI model. For example, the memory 120 may store a computer-readable instruction set including various processing steps related to an image generation procedure by using generative AI. In detail, the memory 120 may store a data set including a procedure for generating prompts based on attribute values related to a 3D object, a correction algorithm for automatically adjusting the weights of attribute values depending on cut attribute information, and a rule for linking the attribute values to prompts. Furthermore, the memory 120 may include a cache memory region that temporarily stores settings values entered by the user, objects selected on UI, or cut information.

For example, the memory 120 may store data for supporting various functions of the present device, and a program for operations of the processor, may store pieces of input/output data (e.g., music files, still images, videos, and the like), and may store a plurality of application programs (or applications) running on the present device, pieces of data for operations of the present apparatus, and instructions. At least part of the application programs may be downloaded from an external server through wireless communication.

The memory 120 may include the type of a storage medium of at least one of a flash memory type, hard disk type, a solid state disk (SSD) type, a silicon disk drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory 120 may be separate from the present apparatus, but may be a database connected by wire or wirelessly.

In an embodiment, the processor 130 may operate according to a processing procedure stored in the memory 120, and may process an input value received through the display unit 110 and may generate a result image. The processor 130 may include a natural language processing model 131 and a generative AI model 132, which may operate in conjunction with each other.

In an embodiment, the natural language processing model 131 may generate text-based prompts based on 3D objects and attribute values. The attribute (e.g., a ‘smile expression’, ‘black hair’, and ‘red clothes’) values specified by the user may be converted into natural language sentences through the natural language processing model 131, and the corresponding prompts may be structured as a single sentence or multiple sentences and may be input to the generative AI model 132.

In an embodiment, the generative AI model 132 may generate an image result based on the generated prompt and cut attribute information. In this case, correction logic that adjusts the weight of each attribute value according to the cut attribute information may be applied. For example, when the character's face has small screen occupancy ratio, a method may be implemented to automatically increase the weight of the expression attribute to supplement the possibility of recognition. The generative AI model 132 may include one or more of a style-based image generation model, a text-to-image mapping-based deep learning model, and a diffusion model.

Besides, the processor 130 may simulate the expected results, to which the current setting values is reflected, in a user interface in real time through a preview generation function. This feature enables immediate feedback on the user's setting results and may increase convenience in a process of modifying, supplementing, and regenerating images.

The image generating device 100 may realize more intuitive and accurate generative AI-based image production by combining a user-centric visual setting environment and an automatic weight correction function. A series of processes, from writing prompts, adjusting weights, and creating images, to providing a preview may be integrally performed through the organic linkage between components.

For example, the processor 130 may be implemented with a memory that stores data regarding an algorithm for controlling operations of components within the present device, or a program for implementing the algorithm, and the at least one processor (not illustrated) that perform the above-described operation by using the data stored in the memory. At this time, the memory and the processor may be implemented as separate chips. Alternatively, the memory and the processor may be implemented as a single chip.

At least one component may be added or deleted to correspond to the performance of the components illustrated in FIG. 1. Furthermore, it will be easily understood by those skilled in the art that mutual locations of the components may be changed to correspond to the performance or structure of the system.

In the meantime, each component shown in FIG. 1 refers to software components and/or hardware components such as field programmable gate array (FPGA) and application specific integrated circuit (ASIC).

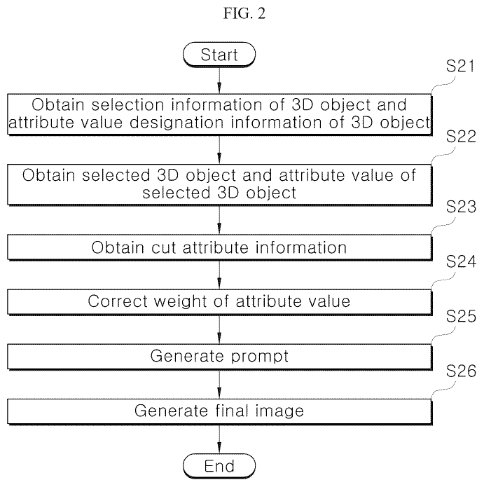

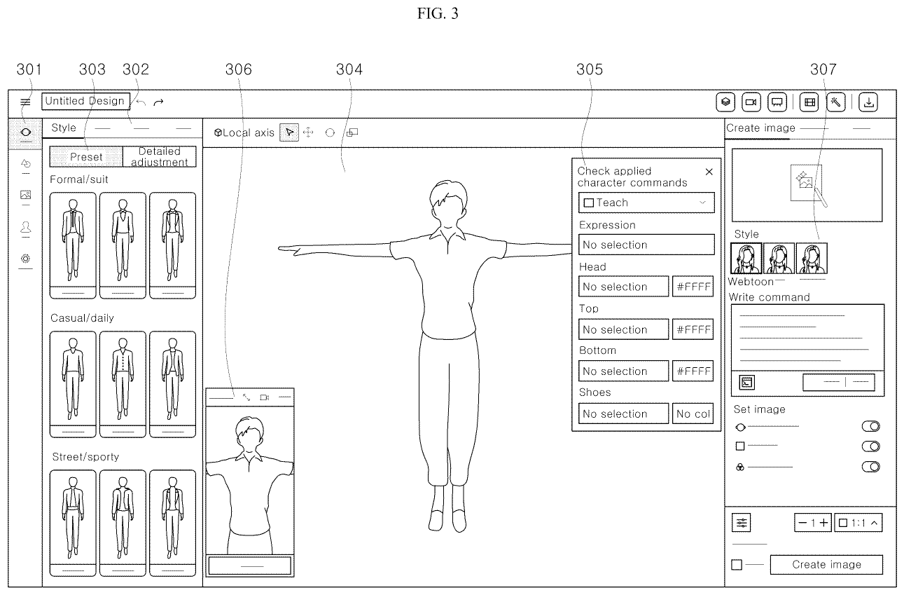

FIG. 2 is a flowchart illustrating an image generation method, according to an embodiment of the present disclosure. FIGS. 3 to 6 are example diagrams showing an image generation method, according to an embodiment of the present disclosure.

Referring to FIG. 2, in an embodiment, in operation S21, the processor 130 may obtain selection information of at least one 3D object for image generation and attribute value designation information of the 3D object through an input interface.

Referring to FIG. 3, the input interface may include a first menu region 301, a second menu region 302, a third menu region 303, a 3D object display region 304, an attribute value display region 305, a preview region 306, and a fourth menu region 307.

In an embodiment, the first menu region 301 may be located at the top left of the input interface, and may separately provide the functions of the entire system in the form of a menu. In detail, main menus of various categories such as characters, elements, backgrounds, my page, and settings may be included, and users may manage the overall flow of character design through this region.

In an embodiment, the second menu region 302 may be displayed in the form of a sub-tab of the first menu region 301, and may provide a detailed menu capable of setting detailed design items such as style, details, motions, and expressions. In particular, when a style tab is selected, a preset and detailed adjustment function, which operates in conjunction with the third menu region 303 and which is capable of being selected by a user, may be activated.

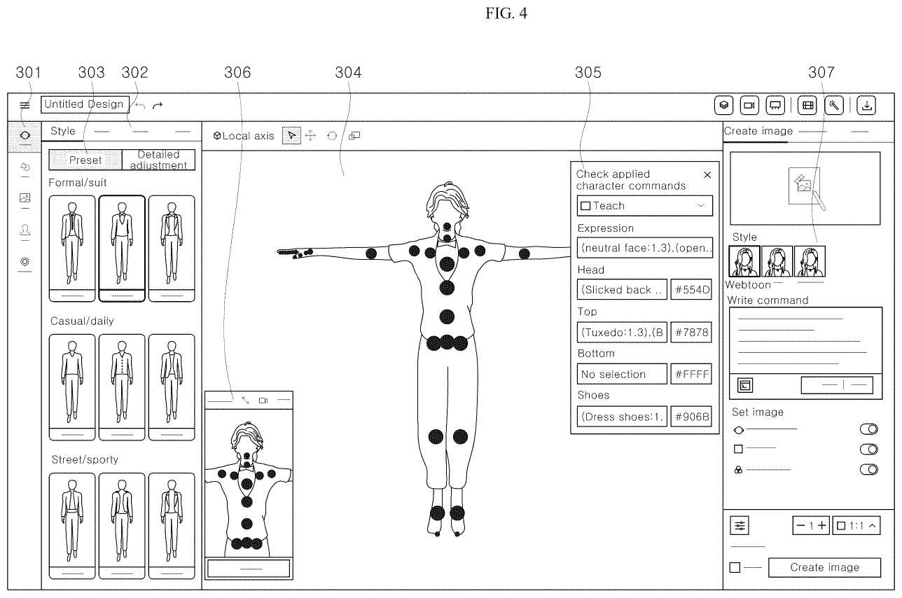

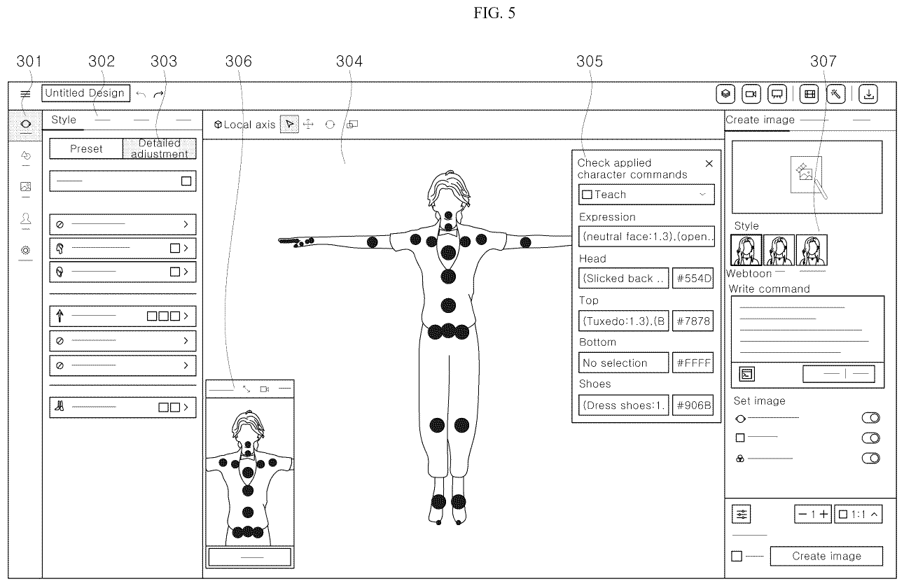

In an embodiment, the third menu region 303 may include preset and detailed adjustment menus. For example, the processor 130 may display a 3D object that allows a user to select formal/suit, casual/daily and street/sporty in the preset. The third menu region 303 may provide a UI for setting a 3D object in a preset or detailed adjustment manner. As shown in FIG. 4, when the user selects the preset such as “Gentleman 01,” the 3D object including a set form of clothing, pose, appearance, etc. may be automatically generated and reflected in the 3D object display region 304. On the other hand, when the detailed adjustment menu shown in FIG. 5 is selected, the user may precisely specify individual attribute values for each configuration unit such as top, bottom, shoes, and accessories.

In an embodiment, the 3D object display region 304 may be a region where a character selected by a user is displayed. The 3D object display region 304 may be a space where the model of the actually selected 3D object is rendered and displayed. Through this region, the user may intuitively identify the appearance of the selected 3D object, the combination status of its components, the camera viewpoint, etc. This region may be updated in real time, and thus may be output in a state where changes in attribute values or styles are reflected immediately.

In an embodiment, the attribute value display region 305 may be a region that attribute value currently applied to the 3D object selected by the user is displayed based on text. For example, an expression, a hair style and color, a top type and color, a bottom type and color, or a shoe type and color may be displayed. This region may be automatically updated based on the user's direct input or visual selection method (e.g., selecting an image option).

In an embodiment, the preview region 306 may provide, in real time, a response of a 3D object, to which user-specified attribute values are applied, in a small viewport format. In particular, this region may be used as a visual reference for identifying the occupancy ratio of a screen occupied by the entire 3D object, or its location within a frame. Afterward, this information may be used as a weight adjustment criterion for automatically generating a prompt.

In an embodiment, the fourth menu region 307 may include a UI for setting additional functions, such as re-selecting a style, manually entering a generation command, or setting the quality of the generated image. In particular, a command writing window may be configured to automatically suggest or reflect, through modification, a prompt candidate to be input into a generative AI model based on current attribute value information. Furthermore, a final image may be generated via a generation button.

In an embodiment, the processor 130 may obtain an attribute value and selection information, which is entered from a user, in a structured form by operating in conjunction with the first to fourth menu regions, and may perform a weight correction process considering cut attribute information on the attribute value. The cut attribute information may consist of a ratio in a screen occupied by the 3D object, a camera angle, a distance, a direction, etc., and the value in the prompt corresponding to each attribute value may be automatically adjusted based on this information.

As a result, operation S21 according to an embodiment of the present disclosure may accurately generate an image that matches user intent through a linkage task with the setting of 3D object based on an input interface, an attribute value input, and the cut attribute information. In addition, as shown in FIGS. 3 to 5, non-expert users may be guided to intuitively configure a 3D object through a visually structured UI.

In an embodiment, in operation S22, the processor 130 may obtain the 3D object selected through the input interface, and an attribute value of the selected 3D object. For example, the attribute value may include at least one of the 3D object's expression intensity, size or speed of a motion, color of hair, color of clothing, or sharpness of a pattern. For example, the processor 130 may obtain identification information of the 3D object selected through the input interface by the user, and attribute value information specified for the 3D object

For example, the 3D object may be a visible element such as a character, an animal, or an object, and is an entity that is intentionally selected and combined by the user. The attribute value may be information obtained by quantifying or qualitatively expressing visual, behavioral, or emotional characteristics applied to each 3D object, and, for example, may include the intensity (e.g., big smiling expression 1.5, smile 1.0, etc.) of an expression, the size (e.g., spread arms widely 1.2) of a motion, the speed (e.g., walking slowly 0.8) of a motion, the color (e.g., blue) of hair, the color (e.g., white) of clothing, the sharpness of a pattern (e.g., bold 1.3), or the like. The attribute value may be text or numeric information entered directly by the user, or may be a graphic element selected via an icon or an image preset in a visual interface. In particular, in some implementations, the attribute value may be automatically mapped onto one of predefined options, and may be stored while weight information operates in conjunction with the corresponding prompt word for each attribute value.

In an embodiment, in operation S23, the processor 130 may obtain cut attribute information through the input interface. For example, the cut attribute information is information for determining the overall composition of the image, and is information for reflecting the expression proportion and location of the 3D object within a frame.

In detail, it may include the type of shooting shot (e.g., a full shot, a medium shot, a close-up shot, etc.), a camera angle (e.g., a high angle, a low angle, an eye level, etc.), a distance (e.g., a close distance, a middle distance, or a long distance) between the 3D object and a camera, a location of the 3D object (e.g., a center, a left, or a right of the screen), and the expected screen occupancy ratio (e.g., 15%, 30%, etc.) occupied by the 3D object in an image. The cut attribute information may be manually specified by the user, or may be automatically calculated through manipulations such as adjusting a location or zooming in/out of the 3D object in a UI. Moreover, in some implementations, the cut attribute information may be automatically updated by analyzing the screen occupancy ratio in real time in a preview state of an image.

In an embodiment, in operation S24, the processor 130 may correct the weight of the attribute value based on the cut attribute information. For example, when the area occupied by the corresponding 3D object in the entire frame is small (e.g., a face appears small in a full shot) even though the same expression intensity value is specified, the visually intended expression effect may not be sufficiently delivered. In this case, the processor may correct in a method of increasing the weight of the corresponding attribute value when the screen occupancy ratio is less than or equal to a predefined threshold value (e.g., 10%). On the other hand, in a case, where an object occupies a large portion of the screen, such as a close-up shot, the same attribute value may cause excessive visual effects, and thus in this case, correction may be made in a direction of reducing the weight. Moreover, because expressions or motions may be perceived visually differently depending on the viewpoint or direction of the object when an angle is a high angle or a low angle, the processor may differently apply a weight adjustment algorithm for each cut attribute type. This correction method may be performed automatically without any additional input from the user, and may optimize the visual expressiveness of attribute values to reflect the user's intent as much as possible.

In an embodiment, in operation S25, the processor 130 may generate a prompt based on the 3D object and the attribute value to which the corrected weight is reflected. For example, the prompt is a sentence or a word string in a natural language form, and functions as a command for inducing the image generation output of an AI model. The prompt is configured to reflect the type of selected 3D object, an attribute value, the corrected weight, a background setting, or the like.

For example, when the 3D object is a male character with blue hair and is set to a close-up shot, the generated prompt may be composed as “male, blue_hair, close-up, smiling expression 1.4”. The corrected weight value is included as a numerical value to emphasize the corresponding attribute, and the generative AI interprets the numerical value to induce the output of an image matching intent. Rather than a static configuration by simple string concatenation, a dynamic configuration method that considers the combination of attributes and the grammatical structure may be applied to the generation of prompts. Also, in some implementations, an interface that a user may modify or edit by providing a prompt preview to a user may also be provided.

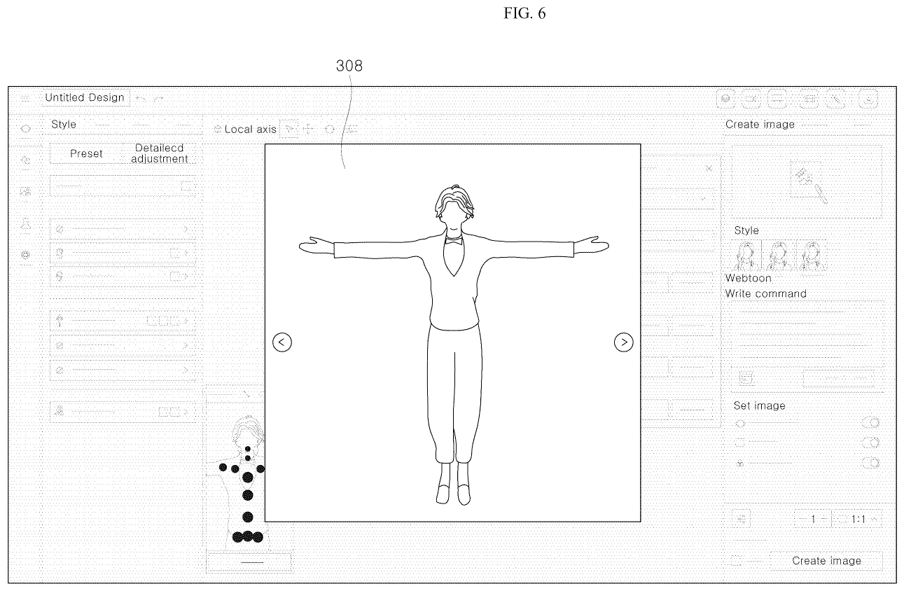

In an embodiment, in operation S26, the processor 130 may generate a final image by inputting the generated prompt into the generative AI model. For example, FIG. 6 shows that a final image 308 is generated. The generative AI model may be implemented as a large-scale multimodal deep learning model based on text-to-image.

For example, information included in the prompt is processed by the model's text encoder, and then visual output is generated through an image decoder. In this process, the correction weight of the attribute value may act as a visual emphasis element and may have a significant impact on the quality of the overall result and the consistency with the user's expectations. The final image may be visually displayed on a user interface and may be stored or used for further editing if necessary. For example, FIG. 6 shows an example of the generated result image 308, and it may be seen that the style and attribute value selected by the user are visually reflected. In this way, through a series of operations S22 to S26 according to an embodiment of the present disclosure, the intuitive settings of the user and the precise output of the generative AI may be efficiently connected.

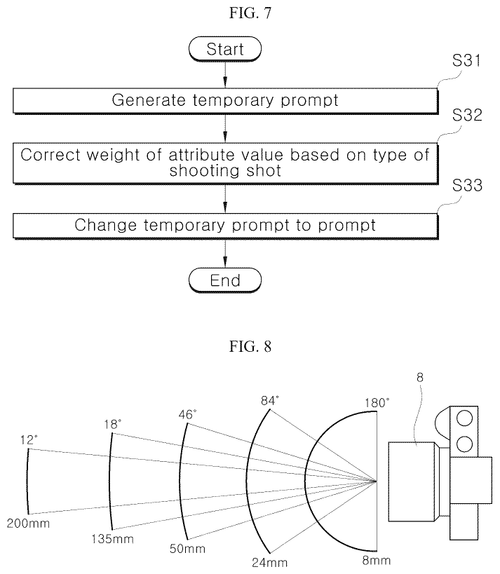

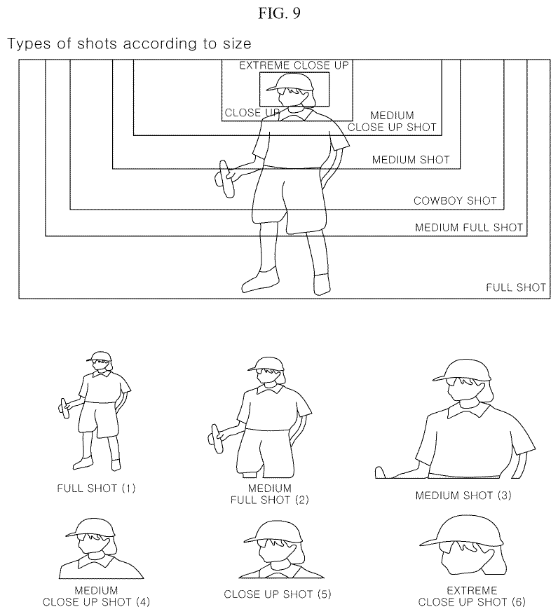

FIG. 7 is a flowchart illustrating a weight correcting method based on a shooting shot, according to an embodiment of the present disclosure. FIGS. 8 and 9 are example diagrams showing a weight correcting method based on a shooting shot, according to an embodiment of the present disclosure.

Referring to FIG. 7, in an embodiment, in operation S31, the processor 130 may generate a temporary prompt based on a 3D object and an attribute value. For example, the processor 130 may generate the temporary prompt based on a 3D object (e.g., character appearance, clothing, expressions, etc.) obtained through an input interface, and one or more attribute values (e.g., expression intensity, a range of motion, hair color, clothing color tone, texture detail, etc.) set for the 3D object.

For example, before being transformed into a final prompt by reflecting weight adjustments and cut attribute information in a subsequent step, the temporary prompt may consist of a basic command string reflecting a user's initial settings and intent. The prompt may be implemented in a natural language, and for example, may be expressed as a phrase such as “smiling boy with short blue hair and white shirt”. Not only when an attribute value is set as a single item, but also when a plurality of attribute values are set in parallel, the processor 130 may analyze the cases to dynamically configure the temporary prompt considering the priority and relevance of each attribute value.

In an embodiment, in operation S32, the processor 130 may correct the weight of the attribute value based on the type of the shooting shot. For example, as shown in FIGS. 8 and 9, the processor 130 may correct the weight of the attribute value based on the cut attribute information such as the type of shooting shot, a camera angle, a distance between a camera and a 3D object, a viewpoint, or field of view.

In particular, the cut attribute information may include shot classification information classified as FULL SHOT (1), MEDIUM FULL SHOT (2), MEDIUM SHOT (3), MEDIUM CLOSE UP SHOT (4), CLOSE SHOT (5), EXTREME CLOSE UP SHOT (6), and the like. For example, in EXTREME CLOSE UP SHOT (6), a facial area occupies most of the entire screen, and thus the detailed description of the expression may be recognized relatively easily. On the other hand, in FULL SHOT (1), the facial expression occupies a small portion of an image, and thus the expression may not be recognized according to the user's intent with the same expression intensity value.

Accordingly, the processor 130 may dynamically correct the weight upward or downward based on a cut attribute for an attribute value such as an expression, hair color, or clothing color. For example, when the intensity of smile expression is set to 1.3, in FULL SHOT (1), it may be corrected to 1.6 to provide a clearer visual effect. In the meantime, in EXTREME CLOSE UP SHOT (6), it may be corrected to 1.1 to prevent an exaggerated expression. Such the corrections may be performed automatically via a predefined threshold value table or a screen occupancy ratio-based calculation formula.

In an embodiment, in operation S33, the processor 130 may change the temporary prompt to the prompt based on a 3D object and the attribute value reflecting the corrected weight. For example, the processor 130 may generate a final prompt by combining attribute value information reflecting the weight corrected in operation S32, and the temporary prompt generated in operation S31.

For example, in the case where the cut attribute information is recognized as FULL SHOT (1), when the initial temporary prompt was “a smiling boy with short blue hair wearing a white shirt”, the final prompt may be reconstructed as a phrase that explicitly reflects the corrected attribute, such as “a boy with exaggerated smile expression (intensity 1.6), short vivid blue hair, and high-contrast white shirt”. In generating the final prompt, the processor 130 may also track a weight change history for each attribute and then may provide it as a prompt log or preview such that the user may understand it visually. Moreover, the final prompt is automatically converted to a structure optimized for the input format of the generative AI model, and thus may improve the accuracy and consistency of the image generation process. While reducing the user's input burden, this method may guarantee automatically optimized image results according to cut characteristics.

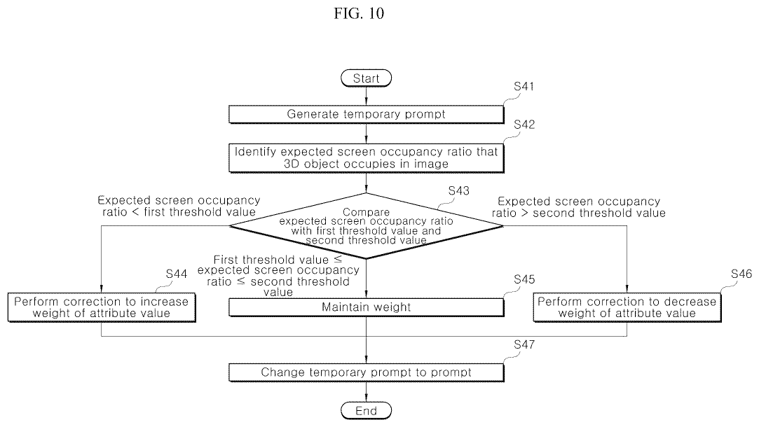

FIG. 10 is a flowchart illustrating a weight correcting method based on expected screen occupancy ratio, according to an embodiment of the present disclosure.

Referring to FIG. 10, in an embodiment, in operation S41, the processor 130 may generate a temporary prompt based on a 3D object and an attribute value. For example, the temporary prompt is in the form of text. For example, the temporary prompt may include a keyword such as “smiling face” when the expression of the 3D object is a smiling face, or may include a phrase such as “blue hair” when the hair color is specified as blue. The temporary prompt has an initial text command state where cut attribute or occupancy ratio-based corrections are not applied, and may provide basic data for conversion into a final prompt through subsequent operations.

In an embodiment, in operation S42, the processor 130 may identify the expected screen occupancy ratio that the 3D object occupies in the image. For example, the expected screen occupancy ratio at this time may be calculated as the ratio of pixels of the image occupied by a bounding box of the 3D object to the total number of pixels in an image, and may be automatically calculated through an image rendering engine or preprocessing algorithm. For example, when a character's face occupies more than 60% of the entire screen in a close-up angle, the occupancy ratio value may be measured as 0.6 or higher.

In an embodiment, in operation S43, the processor 130 may compare the expected screen occupancy ratio with a preset first threshold value and a preset second threshold value. For example, the first threshold value is a reference value with a relatively low occupancy ratio, and may be set to, for example, 0.2. The second threshold value is a reference value with a high occupancy ratio, and may be set to, for example, 0.5. These threshold values may be predefined through user settings or learning-based statistics so as to be stored, and may be used as criteria for determining the need for visual emphasis based on an occupancy ratio.

In an embodiment, when the comparison result indicates that the expected screen occupancy ratio is less than the first threshold value, in operation S44, the processor 130 may perform the correction to increase the weight of the attribute value. For example, when the comparison result indicates that the expected screen occupancy ratio is less than the first threshold value (i.e., when there is the possibility that the corresponding object is capable of being expressed too small in the image), the processor 130 may perform compensation by increasing the weight of the attribute value. For example, when the occupancy ratio is low in the case where the weight set to emphasize the character's smile expression is originally 1.3, the weight may be adjusted upward to 1.6 such that an expression is capable of being pronounced visually. These weight adjustments have a numerical effect on the attribute values in a step prior to the prompt generating step, and may induce clearer visual effects in the image generating step.

In an embodiment, when the comparison result indicates that the expected screen occupancy ratio exceeds the second threshold value, in operation S46, the processor 130 may perform the correction to decrease the weight of the attribute value. For example, when the character is in a close-up scene with a very large proportion of the image, lowering the weight of the smile expression from 1.3 to 1.0 is sufficient for visual recognition, and thus the weight may be reduced to prevent over-expression. This may be a technique for preventing exaggerated expressions of generated images and obtaining natural results that match user intent.

In an embodiment, when the comparison result indicates that the expected screen occupancy ratio is greater than or equal to the first threshold value and less than or equal to the second threshold value, in operation S45, the processor 130 may maintain the weight. That is, when the expected screen occupancy ratio falls within the intermediate range, the weight of the currently set attribute value may be maintained. This is a range where the weight set by default is determined to be within a range that does not cause problems with visual expression, and thus computational waste may be reduced and natural image creation may be guaranteed by reflecting the existing attribute values as they are without unnecessary adjustments.

In an embodiment, in operation S47, the processor 130 may change the temporary prompt to the prompt based on a 3D object and the attribute value reflecting the corrected weight. For example, the final prompt at this time is a sentence-type prompt reflecting both the user's input information and cut attribute-based correction, and may be used as a command that is directly input into the generative AI model to instruct image creation. For example, when the screen occupancy ratio is determined to be high in the close-up and thus the corrected weight is applied, when the initial temporary prompt is “smiling face, blue hair”, the final prompt may be adjusted to “smiling face (1.0), vivid blue hair (0.9)”. In this way, the final prompt may be configured in an optimized form reflecting the balance of user intent, screen components, and visual effects.

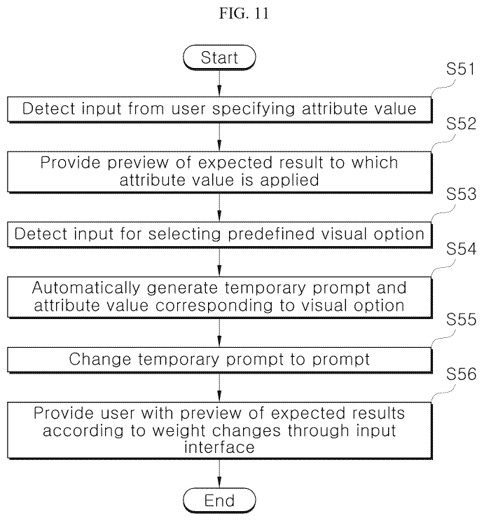

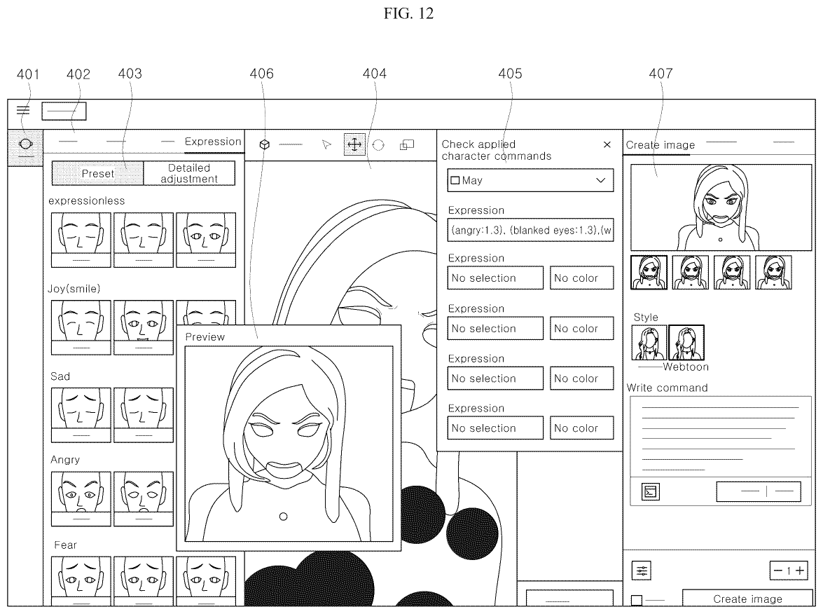

FIG. 11 is a flowchart illustrating a preview providing method, according to an embodiment of the present disclosure. FIG. 12 is an example diagram illustrating a preview providing method, according to an embodiment of the present disclosure.

Referring to FIG. 11, in an embodiment, in operation S51, the processor 130 may detect an input through which a user specifies an attribute value via an input interface.

For example, as illustrated in FIG. 12, the input interface may include a first menu region 401, a second menu region 402, a third menu region 403, a 3D object display region 404, an attribute value display region 405, a preview region 406, and a fourth menu region 407 The user may access the overall function classification menu through the first menu region 401, may access detailed editing items through the second menu region 402, and may select an expression selection function through the third menu region 403. A user interface configured in this way may improve user convenience by providing an environment in which various editing items are capable of being intuitively selected.

In an embodiment, when detecting an input through which the user specifies the attribute value through the input interface, in operation S52, the processor 130 may provide a preview of the expected result to which the attribute value is applied. For example, referring to FIG. 12, when the user selects a ‘mad’ expression in the third menu region 403, the character image reflecting the expression may be immediately reflected in the 3D object display region 404, and may be provided in an enlarged form through the preview region 406 at the same time. In this way, the user identifies a form close to the actual result in advance, thereby increasing the predictability of the editing result. This configuration may supplement the uncertainty of a generative AI and may improve user experience.

In an embodiment, in operation S53, the processor 130 may detect an input through which the user selects a predefined visual option. For example, the visual option may consist of a specific set of expressions, styles, clothing combinations, etc. When the user selects a style such as ‘Brown Hair, Sleeveless Black Shirt’ in the fourth menu region 407, the corresponding attribute value combination may be set automatically. This configuration makes it easy to set up complex attribute combinations, which may increase user convenience.

In an embodiment, when detecting an input through which the user selects the predefined visual option, in operation S54, the processor 130 may automatically generate an associated prompt and an attribute value corresponding to the visual option. For example, when the selected visual option is ‘brown hair+mad expression’, a prompt such as ‘brown hair:1.3, angry face:1.3, blanked eyes:1.3’ may be automatically generated. In this way, the user burden of generating prompts may be reduced by linking a visual selection input to prompt generation. Additionally, the generation of the associated prompt may be performed based on a predefined attribute-prompt mapping table.

In an embodiment, in operation S55, the processor 130 may change a temporary prompt to a final prompt. For example, the prompt may be composed in a natural language format and may be output in a form in which various elements such as attribute values, styles, and poses are combined. The prompt may be input to the generative AI model in the form of text, to which attribute values such as ‘1girl, solo, long_hair, looking_at_viewer, brown_hair:1.3, angry_face:1.3, clenched_teeth:1.2’ are reflected. Such the structure may improve the quality of the prompt, thereby increasing the accuracy of the generated image.

In an embodiment, in operation S56, the processor 130 may provide a user with a preview of the expected results according to weight changes through the input interface before generating the final image. Furthermore, when detecting the user's retry function input, the processor 130 may provide an interface for changing some of the weights or prompts. For example, when the user adjusts the weight of a specific attribute value from 1.3 to 1.6, the image reflecting the corresponding change may be displayed in the preview region 406 so as to be compared. In addition, the user may press a retry button through the fourth menu region 407 so as to be switched to an interface for changing attribute values or prompts. In this way, the user may intuitively improve results without having to go through repetitive prompt modifications, thereby improving the efficiency and satisfaction of generative AI-based content creation.

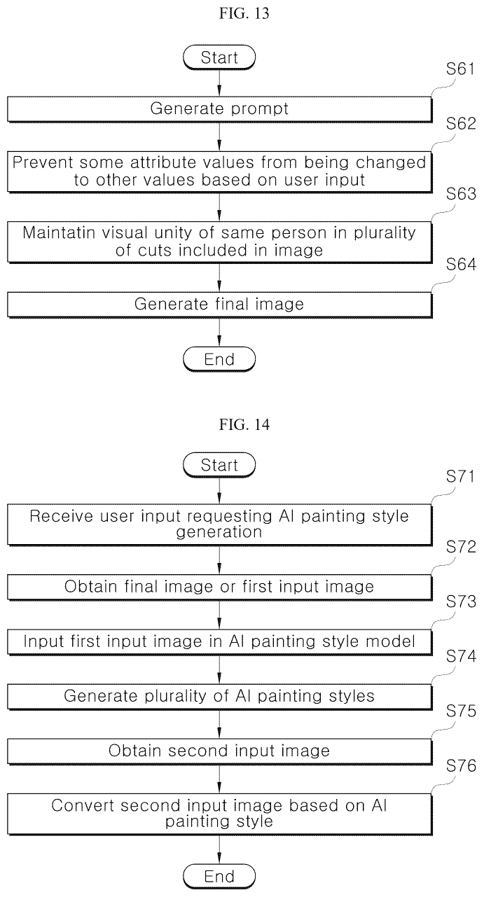

FIG. 13 is a flowchart illustrating a method for preventing attribute value changes and ensuring visual uniformity, according to an embodiment of the present disclosure.

Referring to FIG. 13, in an embodiment, in operation S61, the processor 130 may generate a prompt. For example, the processor 130 may generate the prompt based on input data including cut attribute information and an attribute value of a 3D object. The prompt may consist of a text sentence and may function as a command for inducing image creation after the command is input into a generative AI model. The prompt may include attribute information such as a 3D object's expression, hair color, clothing, and motion in a natural language, and each attribute value may be described together with a weight. Moreover, expressions that are adjusted such that visual emphasis that needs to be expressed at a point in time of the corresponding cut is clearly revealed may be included in the prompt, by reflecting the cut attribute information (e.g., close-up, an angle, a distance, etc.).

In an embodiment, in operation S62, the processor 130 may prevent some attribute values from being changed to other values based on a user input. For example, the weight may be maintained at a certain level or higher, or a negative prompt may be additionally applied, such that the generative AI fails to randomly produce different result values by forcibly fixing a core attribute value such as “a specific hair color” or “a specific expression” through user assignment.

For example, the processor 130 may lock a certain attribute value into a value of an unchangeable state based on a user input. For example, when an attribute value, such as “black hair” or “smiling expression” is set to be explicitly selected and fixed by a user, the processor 130 may maintain a high weight for the corresponding attribute and may allow contradictory results not to be produced. In more detail, unwanted attribute changes may be controlled not to occur by inserting a reinforcement phrase for the corresponding attribute into the internal expression of a prompt including the attribute value, or by additionally configuring a negative prompt to assists the reinforcement phrase. For example, the consistency of results may be enhanced by inserting “black hair, smile” into the prompt and adding “no blonde hair, no angry face” to the negative prompt.

In an embodiment, in operation S63, the processor 130 may maintain visual uniformity of the same character across a plurality of cuts included in an image. For example, when the attribute value of each cut is arbitrarily changed when the plurality of cuts include the same character or object, the user's immersion may be reduced or a result different from intent may be produced, and thus the processor 130 may compare and analyze attribute values of all cuts included in the image. When the analysis results indicates that a mismatch between items such as color, expression, and clothing is identified, weights for the mismatched items may be adjusted again, and a new prompt may be generated based on the attribute value of the previous cut to call the generative AI model again. Furthermore, when there is a change (e.g., transition from a full shot to a close-up shot) in cut attribute, re-correction is performed based on attribute values and weights used in the previous cut, and the corresponding change history is notified to the user through a UI, and thus the user decides whether to automatically update a prompt.

In an embodiment, in operation S64, the processor 130 may generate a final image. For example, when the final image is generated, each attribute value may be included in a natural language expression in the prompt, and after being combined with cut attribute information, more specific and clear generation conditions may be provided to the generative AI model. As a result, high-precision images that exactly reflect the user's intent may be generated, and in particular, results that clearly reflect key attributes such as a character's expression, hair color, and clothing may be consistently secured.

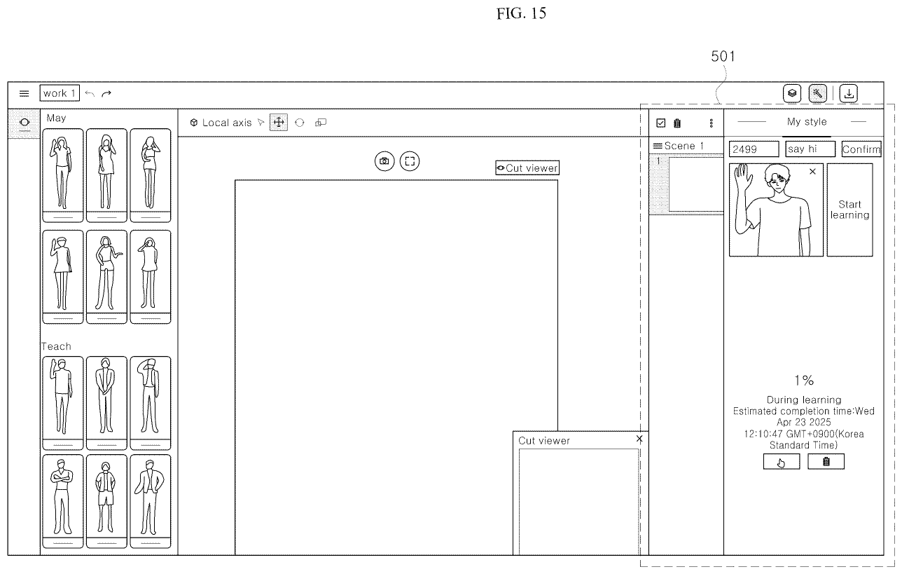

FIG. 14 is a flowchart illustrating an image converting method based on AI painting style, according to an embodiment of the present disclosure. FIGS. 15 to 19 are example diagrams showing an image converting method based on AI painting style, according to an embodiment of the present disclosure.

Referring to FIGS. 14 to 19, a device 100 according to an embodiment of the present disclosure may generate an AI painting style by using a generated final image or an input image additionally registered by a user, and may convert various images based on the AI painting style. That is, the present disclosure may generate various AI painting styles by using AI by inputting even though only one input image is entered, and may convert an image into an image desired by the user based on a plurality of AI painting styles.

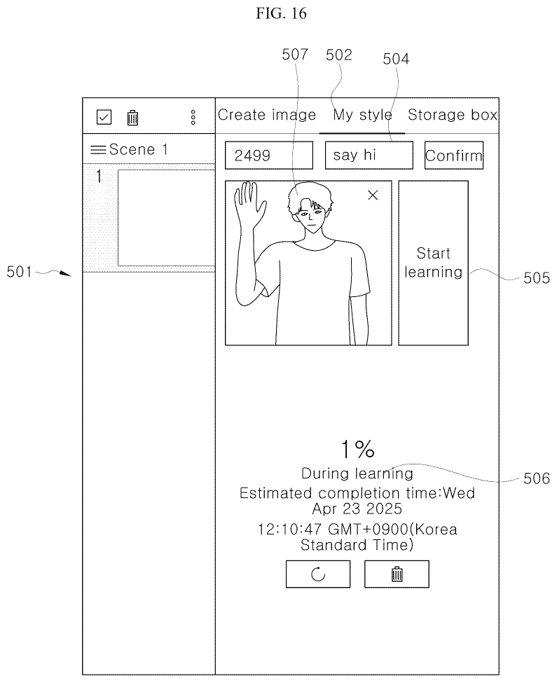

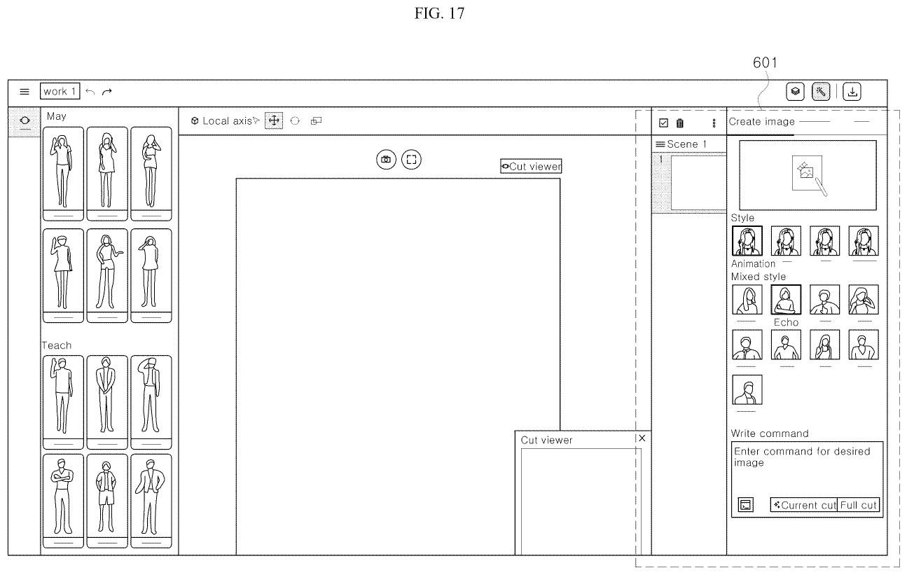

In an embodiment, in operation S71, the processor 130 may receive user input requesting AI painting style generation. For example, a user interface may be configured as shown in FIGS. 15 and 16, and a ‘my style’ menu 502 is located at the top of the user interface, and thus the user may enter an initial setup procedure for creating the user's AI painting style by clicking the menu. The user may upload a first input image 507 drawn by the user onto an input image region 501, and may give meaning to the motion by inputting a text command such as ‘say hi’ into a motion input region 504. After the input operation is performed, when the user clicks a confirm menu, the preparation for image learning may be completed, and then a learning process for creating an AI painting style may be initiated by clicking a start learning menu 505.

In an embodiment, in operation S72, the processor 130 may obtain the first input image 507 uploaded from the user. The first input image 507 may be an image drawn directly by the user, and the image may include various visual elements such as the appearance, posture, expression, and color of a specific character. The processor 130 may receive the first input image 507 in a high-resolution vector format or raster image format, and may then perform preprocessing such as texture separation, edge detection, and color segmentation to be used for generating AI painting styles.

In an embodiment, in operation S73, the processor 130 may perform learning of an AI painting style model based on the first input image 507. For example, a learning progress rate may be displayed in real time through a learning region 506 of FIG. 16, and the learning may be performed by extracting the feature vector of the first input image 507 and applying the feature vector to a deep learning model of various expression forms. The processor 130 may generate an AI painting style model that reflects the user's image style, by vectorizing morphological features (e.g., an eye shape, a hairstyle, a clothing pattern, etc.) detected from the first input image 507 through a CNN or Vision Transformer-based encoder and providing them as learning data to a generative model (GAN, Diffusion, etc.).

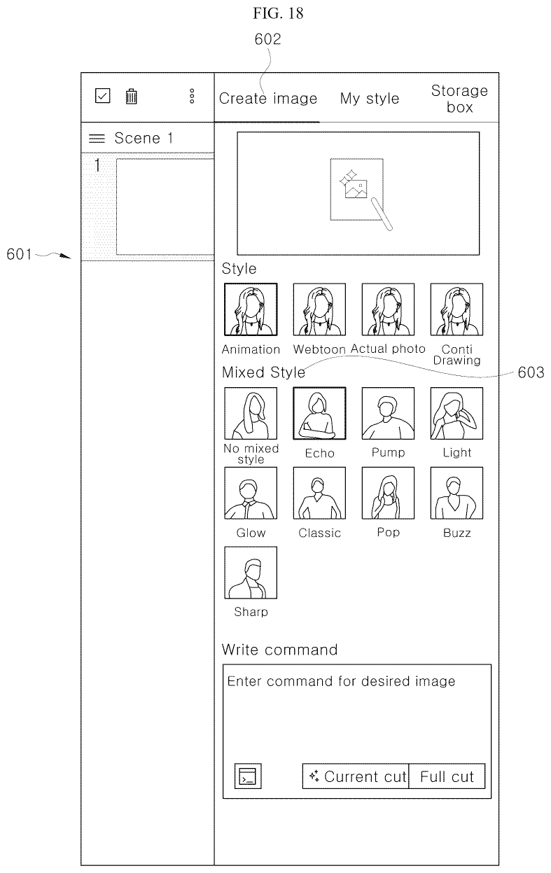

In an embodiment, in operation S74, the processor 130 may generate a plurality of AI painting styles based on the learned AI painting style model. For example, through an image generation tab 602 illustrated in FIGS. 17 and 18, the user may visually identify a mixed style 603 such as echo, pump, light, classic, glow, pop, buzz, and sharp, and each style is an independent visual painting style generated by mapping features extracted from the user input image to various visual expression structures of the AI model. Each painting style may provide different results in brush stroke texture, line intensity, color saturation, and contrast depending on style characteristics, and the user may compare and select them.

In an embodiment, in operation S75, the processor 130 may obtain a second input image 701 from a user. The second input image 701 may be a different image from the original image and may include the character's posture, clothing, expression, background, etc. The user may select one of the previously created AI painting styles, and request image conversion by using the corresponding style, by uploading this image.

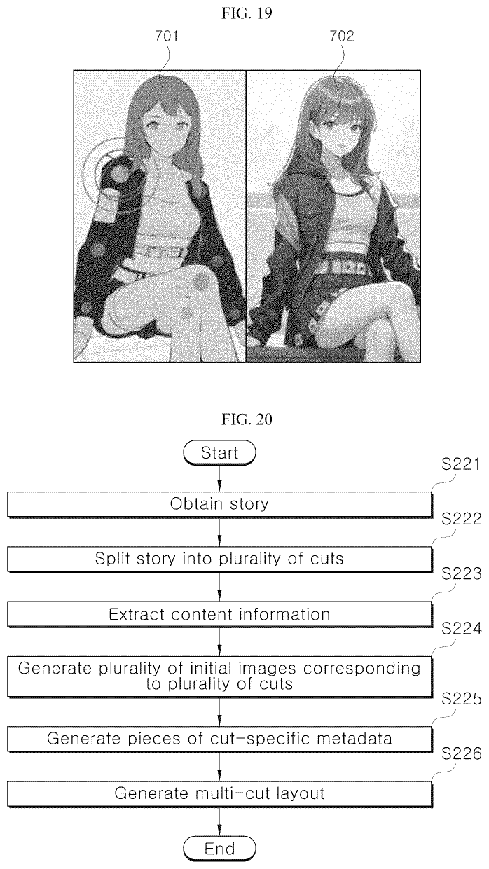

In an embodiment, in operation S76, the processor 130 may convert the second input image 701 by applying a specific AI painting style to the second input image 701 depending on a user selection. For example, as shown in FIG. 19, the second input image 701 may be a general image, and the processor 130 may convert the second input image 701 into a final image 702, to which a specific AI painting style is applied, by applying the selected AI painting style. In this case, style application may be processed through a plurality of decoder layers, by including color mapping, texture insertion, contrast adjustment, and outline enhancement. As a result, the final image, to which an AI painting style having visual perfection that meets the user's expectations is applied, may be generated.

In an embodiment, the processor 130 may provide the converted final image to the user and may provide various post-processing options on a user interface such that the user may store, modify, or reuse the image. For example, through the image editing tools shown in the drawing, the user may perform repetitive tasks such as modifying certain elements of a styled image or applying a new style again so as to be compared. In addition, the present system may provide the function of storing AI painting styles and providing favorite functions such that repeated use of the user is possible.

Above, referring to FIGS. 1 to 19, according to an embodiment of the present disclosure, an image generating device and a method thereof that may precisely control image output of a generative artificial intelligence based on an attribution value of a 3D object are described in detail.

Hereinafter, with reference to FIGS. 20 to 30, an image generating device and a method thereof that may generate a multi-cut image in the form of a webtoon according to an embodiment of the present disclosure will be described in detail.

The image generating device 100 according to an embodiment of the present disclosure may automate the production process of webtoons, storyboards, interactive visual content, etc. by automatically configuring image content in a multi-cut form based on a text-based story entered by a user, and supporting user-customized regeneration of the generated images.

In an embodiment, the display unit 110 may provide an input interface for obtaining a story. For example, the display unit 110 may serve as an interface between the user and the system, and in particular, may visually provide a text input window for a story input, a user interaction region for multi-cut editing, and a selection screen for regenerated image candidates. The display unit 110 may be implemented as a display device including a touch screen, a keyboard input window, a mouse selection region, or a graphical user interface (GUI), and may allow the user to input a story sentence described in natural language or to identify the content of an uploaded story file. Moreover, the display unit 110 may render generated multi-cut images, results with speech bubbles and effect texts placed, and regenerated image candidates in an intuitive manner so as to be provided to the user.

In an embodiment, the memory 120 may store at least one process related to an operation of generating a story image by using the story. In particular, the memory 120 may store model parameters of the natural language processing model 131 and the generative AI model 132, learned keyword-attribute mapping table, image generation prompt information, cut-by-cut metadata set, template-based layout configuration information, etc., and may read or update the corresponding information in real time according to the command of the processor 130. Furthermore, it is possible to continuously accumulate and store user-customized content data based on the user's story writing history, selected regenerated image, preferred layout, etc.

In an embodiment, the processor 130 may perform operations according to the process and may include the natural language processing model 131 and the generative AI model 132. For example, the processor 130 may control a series of operations of analyzing a story input from the user by executing various processes stored in the memory 120, dividing the story into a plurality of cuts, extracting content elements to be included in each cut, generating a prompt for image generation, calling a generative AI to generate the image result, automatically configuring a multi-cut layout based on the generated image and metadata, and providing alternative image candidates upon a subsequent regeneration request.

In detail, the processor 130 may include the natural language processing model 131 and the generative AI model 132. The natural language processing model 131 may divide the input story into sentences or paragraphs, may extract content elements such as characters, objects, backgrounds, motions, time, places, and emotional expressions based on keywords, and may analyze a context flow such that the content elements are appropriately split into each cut. For example, cut segmentation boundary candidates may be set based on the appearance of a character, a scene change, start of a conversation, etc., and the cut structure may be automatically configured.

In the meantime, the generative AI model 132 may generate an image based on cut unit content elements delivered from the natural language processing model 131, may configure a prompt corresponding to each cut, and may generate a high-quality 2D or 3D-based cut image by reflecting the expression, composition, background, style, etc. of the image. The generative AI model 132 may include a 3D rendering model, a GAN-based model, or a diffusion-based model that performs text-to-image conversion, and may also generate metadata for automatically arranging the generated images in a multi-cut layout.

Moreover, when receiving a request for image regeneration for a specific cut from the user, the processor 130 may generate a plurality of image candidates based on metadata for the corresponding cut to display them through the display unit 110, and may also perform an update operation of the multi-cut layout by replacing the image candidate selected by the user with the original cut image. In this way, the processor 130 may provide the user with an automated image content creation environment by sequentially and organically controlling planning-creation-editing-regeneration stages of the entire system.

The linkage structure between such components may be configured such that when a user input occurs in the display unit 110, the processor 130 detects the user input, loads the necessary process from the memory 120, performs natural language processing and image generation, and then transmits the result back to the display unit 110 for visual feedback. Besides, cut layout reconstruction and candidate image selection that may occur during the regeneration process may be repeatedly performed through the same path. This configuration may support the user's repetitive editing task intuitively and quickly, and may provide a consistent user experience.

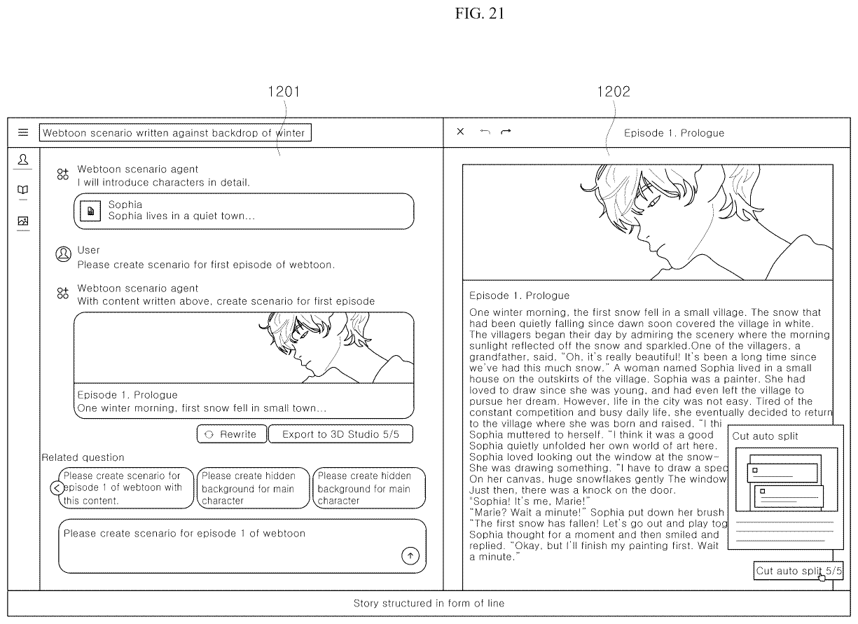

FIG. 20 is a flowchart illustrating a method for generating a multi-cut layout, according to an embodiment of the present disclosure. FIGS. 21 to 23 are example diagrams showing a method for generating a multi-cut layout, according to an embodiment of the present disclosure.

Referring to FIG. 20, in an embodiment, in operation S221, the processor 130 may obtain the story through the input interface. For example, in this case, a user input region 1201 may be configured as a chat-type interface, and a user may sequentially input a scenario in sentence units or paragraph units through the corresponding region. The input story may include various content elements such as a line, a situation description, a background explanation, and a character's emotion that make up a story development flow.

Moreover, the processor 130 may split sentences entered by the user into grammatical structure and semantic units by using the natural language processing model 131 and then may analyze the flow and meaning within the story. As shown in FIG. 21, the form of text, which is written by the user after the analyzed story is reflected in real time in a story display region 1202 and which is stored and processed in a system, may be intuitively identified. The story display region 202 may provide the entire input scenario in a page format, and thus the user may visually identify the development structure of the scenario.

In an embodiment, in operation S222, the processor 130 may analyze the obtained story to split the story into a plurality of cuts. For example, according to the features of the present disclosure, cut segmentation may be performed in a high-dimensional segmentation method that reflects semantic context and scene transition rather than a simple segmentation based on the number of sentences. For example, time changes, location changes, the occurrence of major events, and breaks in the flow of dialogue between characters may serve as triggers for splitting cuts.

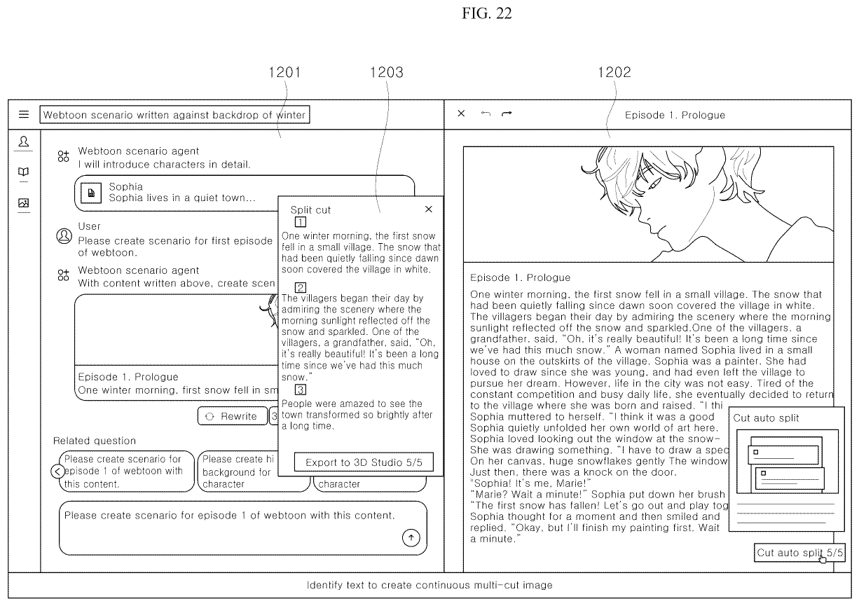

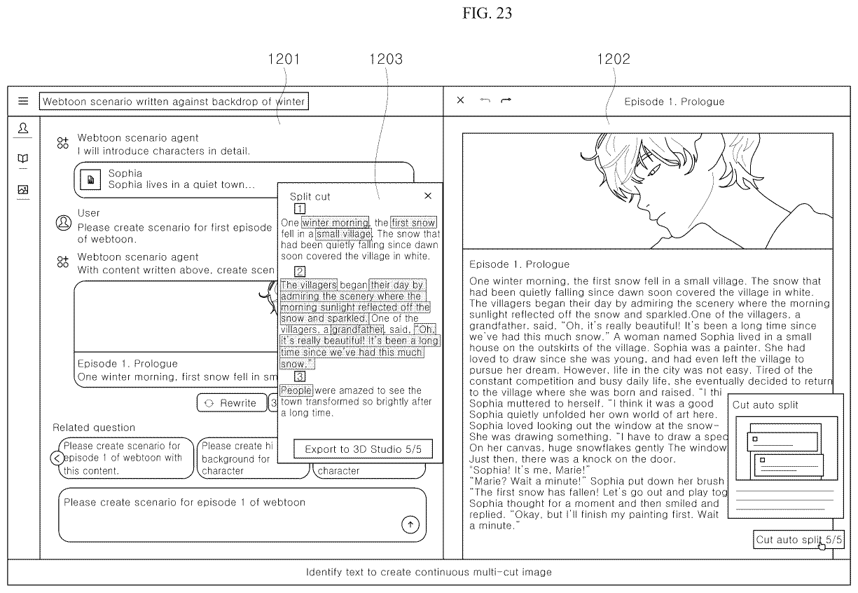

In addition, the processor 130 may detect keywords (e.g., ‘that night’, ‘meanwhile’, ‘but’, ‘a few hours later’, ‘the other side of town’) through the natural language processing model 131 and may set cut boundaries centered on sentences including the keywords. A user may trigger cut segmentation by executing an ‘export 3D story board’ function on an input interface of FIG. 21. As a result, automatically segmented cuts 1203 may be generated and then visually displayed on a left chat interface, as shown in FIGS. 22 and 23. This type of division structure may be used as a unit for a layout configuration and image creation later.

In an embodiment, in operation S223, the processor 130 may extract content information based on text included in each of the plurality of cuts. For example, the extracted content information may include at least one of character information, background information, and object information. Here, the content information may be mainly classified into character information, background information, and object information. For example, when a sentence includes “a boy is walking through a snowy village”, the processor 130 may extract ‘boy’ as the character information, may extract ‘snowy village’ as the background information, and may extract ‘road’, ‘snow’, ‘house’ as the object information.

This information extracting process may be performed by a scene context analysis function and a Named Entity Recognition (NER) function of the natural language processing model 131. In addition, the content information extracted for each cut unit may be used as an input element that constitutes the prompt of the generative AI model 132 in the subsequent image generation process, and the prompt may play an important role in improving visual accuracy.

In an embodiment, in operation S224, the processor 130 may generate a plurality of initial images corresponding to the plurality of cuts based on the extracted content information. For example, the generative AI model 132 may be implemented as a text prompt-based image generation engine, and may automatically generate a visual scene for each cut by using prompts that include information such as extracted characters, backgrounds, and objects.

For example, a prompt obtained by combining information such as “boy”, “snowy country town”, “dawn”, and “lonely atmosphere” may be converted into an image obtained by reflecting a specific painting style, composition, and color tone. The initial image generated in this way corresponds to each cut and may be displayed to the user in a thumbnail format. The processor 130 may generate a plurality of versions of images for each cut in consideration of image resolution, component placement, and a viewpoint (camera angle), etc.

In an embodiment, in operation S225, the processor 130 may generate pieces of cut-specific metadata based on the content information and the plurality of initial images. For example, the pieces of cut-specific metadata may include at least one of character information, background information, object information, motion information, camera angle information, shooting shot information, time information, situation information, and text information.

In particular, the metadata may play a key role in subsequent processing, such as image editing, layout configuration, alternative image regeneration, and user editing. In detail, in addition to character information, background information, and object information, the metadata may include camera angle information (e.g., an eye-level or a bird's-eye), shooting shot information (e.g., a close-up or a long shot), motion information (e.g., walking or talking), time information (e.g., night or morning), situation information (e.g., a rainy day or a tense situation), and text information (a dialogue, a narration, etc.). As illustrated in FIG. 23, the processor 130 may be configured to overlay the corresponding metadata in a visualized form or to provide it in the form of a tooltip such that it may be utilized for user editing. Each metadata item may be structured in the form of tags to be applied for future filtering, classification, conditional regeneration, etc.

In an embodiment, in operation S226, the processor 130 may generate a multi-cut layout based on the generated pieces of cut-specific metadata and the plurality of initial images. For example, the multi-cut layout is a visual interface that sequentially arranges cuts according to the flow of the story, and may be set to either a vertical scroll structure like a webtoon or a horizontal layout structure like a comic book. Spacing between cuts, an image size, an image ratio, a speech bubble location, placement of effect text, etc. may be automatically adjusted based on elements included in cut metadata.

In particular, as shown in the lower right of FIG. 23, a UI capable of selecting or editing an alternative image candidate for each cut image may be configured together, and this configuration may maximize user convenience and intuitiveness. When a user clicks or drags a specific cut in a multi-cut layout, the processor 130 may be designed to perform operations such as modifying, deleting, or regenerating the corresponding cut based on the associated metadata. This will ultimately support high-quality content editing.

In the meantime, according to an embodiment of the present disclosure, the processor 130 may generate the multi-cut layout to minimize interference between cuts in consideration of special symbols, punctuation marks, scene transition keywords, time transition keywords, location transition keywords, the size of each cut image, the spacing between cuts, and the location of a speech bubble, and the location of effect text, which are included in the text of the story.

In detail, in an embodiment, the processor 130 may analyze various structural elements included in the text of the story and may generate a multi-cut layout to minimize layout interference between cuts. In more detail, the processor 130 may recognize special symbols (e.g., ‘#’, ‘*’, etc.) included in the story as a signal of context switching, and may assign a cut splitting or emphasis effect centered on the sentence where the special symbol is located. For example, when a sentence ‘#childhood memories’ is included in the text, this may mean the start of a flashback (reminiscence) scene, and thus the background of the corresponding cut may be expressed with a blur effect or a color tone change. In this way, a visual conflict between cuts may be prevented by naturally visualizing the transition context of a cut.

In addition, the processor 130 may subdivide a meaning paragraph based on punctuation marks (e.g., a period, a comma, an exclamation mark, a question mark, etc.) and may adjust the split location of a cut such that the discontinuity of meaning is revealed naturally. For example, a structure where speech bubbles are placed within the same cut based on a comma (,) in a section where a conversation continues, and strong emotional changes or reactions between characters are emphasized by using exclamation marks (!) or question marks as cut transition signals in sentences where exclamation marks (!) or question marks appear may be automatically created.

Moreover, the processor 130 may automatically segment scene-by-scene cuts by recognizing scene transition keywords (e.g., ‘that night’, ‘after a while’, ‘meanwhile’, ‘the next morning’, etc.), time transition keywords (e.g., ‘a few hours ago’, ‘two days later’, ‘3 p.m.’, etc.), and location transition keywords (e.g., ‘in front of the school’, ‘cabin in the woods’, ‘the other side of the city’, etc.). In this process, the spacing between cuts or the background image transition effect may be automatically adjusted to maintain a smooth sequence flow without visual interference between cuts. For example, when a time keyword such as ‘after a while’ is inserted, the flow of time may be visually expressed by setting blank space between a cut where the corresponding text is inserted, and the next cut, or by inserting a scene transition animation effect (fade-in, wipe, etc.).

Besides, the processor 130 may analyze the size of each cut image to adjust its relative arrangement order in a layout. For example, when a specific cut image is created as a full shot or wide shot to express a wide space, the cut may be arranged to occupy a single row, and subsequent close-up cuts or dialogue-centered cuts may be reorganized into a two-level arrangement or column-divided structure, thereby securing visual contrast and concentration.

Moreover, the spacing between cuts may be variably adjusted by reflecting emotional intensity, transitions, and distance between characters included in metadata of each cut. For example, in scenes where a conflict between characters becomes intense, the spacing between cuts may be narrowed to induce tension. When scenes change or a calm atmosphere is expressed, the spacing between cuts may be widened to secure visual space.

Finally, the processor 130 may prevent collisions with the placement of elements inside a cut image in consideration of locations of speech bubbles and effect text. For example, when a speech bubble needs to be located at the top center, image generation may be adjusted in advance, or the location of a speech bubble may be automatically relocated to the upper right or upper left such that a character's face or an important background element is not located at the corresponding location. An effect text (e.g., ‘Thud!’, ‘Pang!’, ‘Swoosh!’) may be automatically placed in an appropriate location and size in consideration of the text emphasis effect and the contrast with the visual elements within a cut.

Through creating a multi-cut layout that comprehensively considers such elements, an image generating device according to an embodiment of the present disclosure may prevent a visual conflict between cuts and may provide a content production environment that naturally continues the flow of the story.

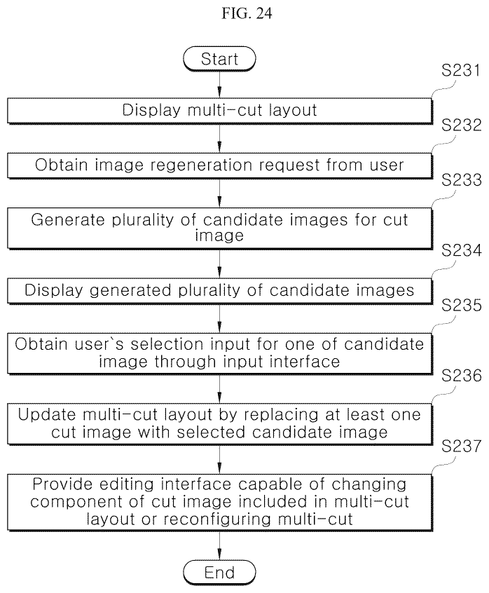

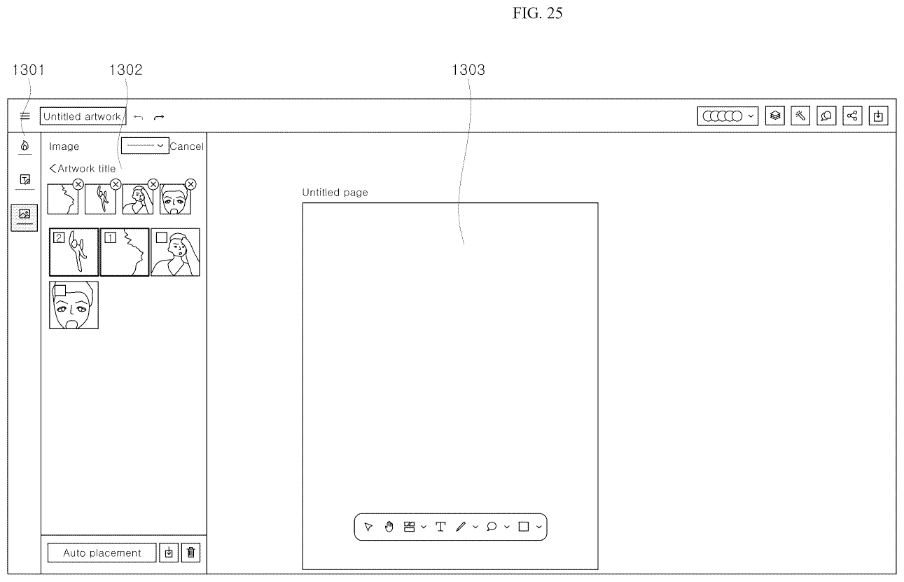

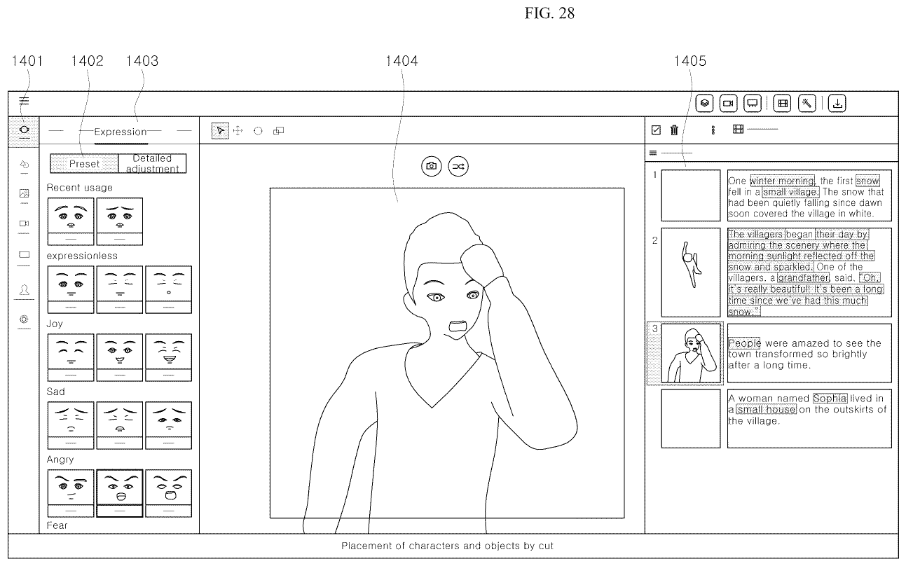

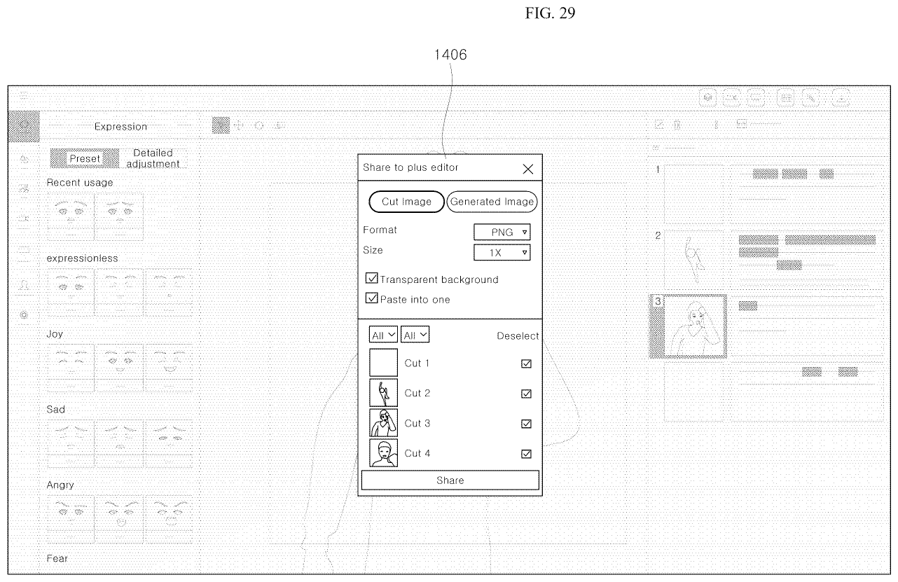

FIG. 24 is a flowchart illustrating a method for updating a multi-cut layout, according to an embodiment of the present disclosure. FIGS. 25 to 27 are example diagrams showing a method for updating a multi-cut layout, according to an embodiment of the present disclosure. FIGS. 28 and 29 are example diagrams showing a method for providing an editing interface, according to an embodiment of the present disclosure.

Referring to FIG. 24, in an embodiment, in operation S231, the processor 130 may display the multi-cut layout via the input interface. For example, referring to FIG. 25, the input interface may be composed of various selection regions capable of being manipulated by a user, and may include a menu region 1301, a cut display region 1302, and a multi-cut layout display region 1303. The menu region 1301 may be formed in a structure in which the user is capable of immediately accessing an editing purpose, by listing functional categories such as ‘sound effects’, ‘stories’, and ‘image’ in a tab format. The cut display region 1302 may provide a function, which allows the user to select individual cuts or change the order while images in the form of thumbnails are arranged for each cut. The multi-cut layout display region 1303 visually displays the placement of cuts on a storyboard, and thus the flow and layout of the entire cut may be intuitively identified.

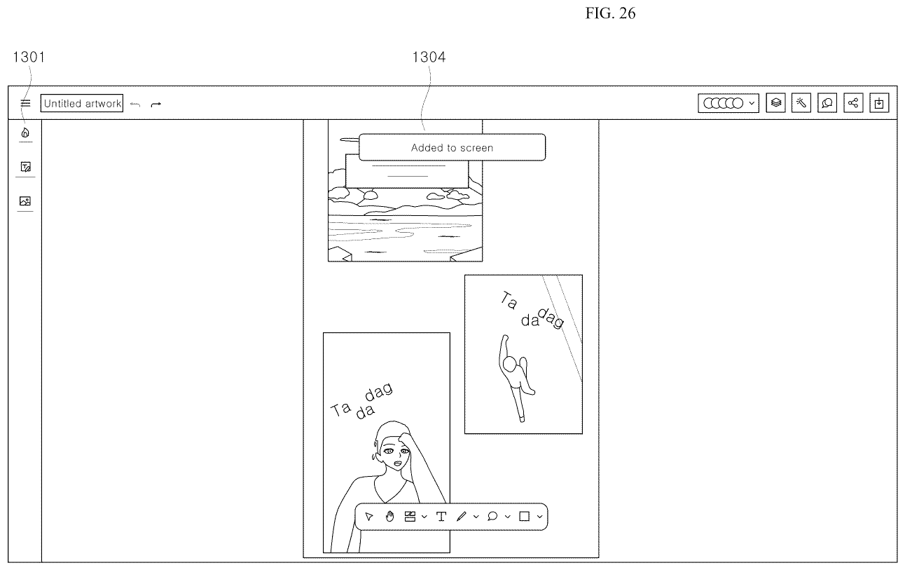

For example, as shown in FIG. 26, when the user selects an ‘auto-place’ function through the menu region 1301, the processor 130 may automatically generate a multi-cut layout 1304 and may place the multi-cut layout 1304 in the multi-cut layout display region 1303. In the case, an automatic placement operation may configure the layout to minimize visual interference by comprehensively considering the order of cuts, an image size, a background attribute, and a speech bubble location.

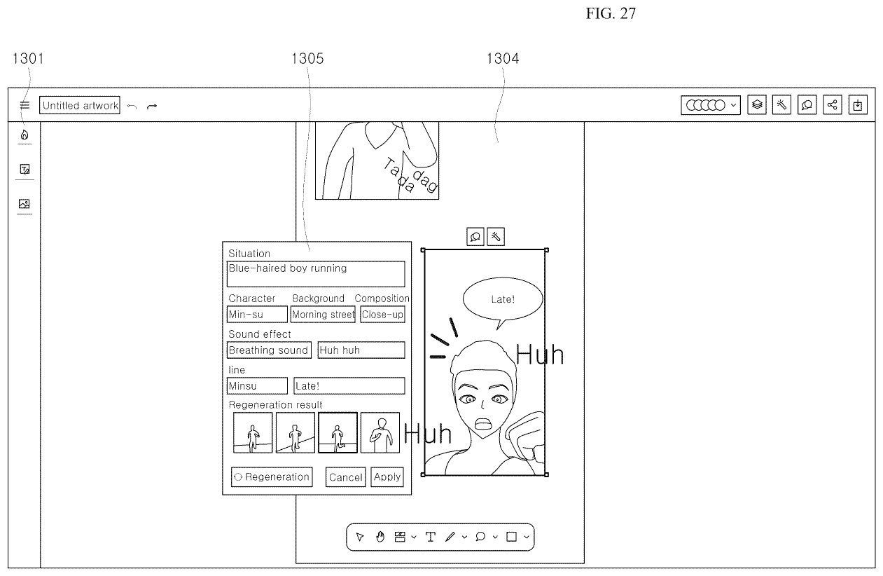

In an embodiment, in operation S232, the processor 130 may obtain an image regeneration request for at least one cut image included in the multi-cut layout from the user through the input interface. For example, referring to FIG. 27, when a user clicks one cut image included in the multi-cut layout 1304, the processor 130 may output an image regeneration menu region 1305 for the corresponding cut to a screen. The image regeneration menu region 1305 may be configured to input or select various modification items (e.g., a ‘situation’, a ‘character’, a ‘background’, a ‘composition’, a ‘sound effect’, and a ‘dialogue’) based on metadata items included in the selected cut.

In an embodiment, in operation S233, the processor 130 may generate a plurality of candidate images for the at least one cut image based on metadata of a cut corresponding to the at least one cut image in response to the image regeneration request. For example, the processor 130 may generate the plurality of candidate images by using at least one of changing, deleting, or adding a component included in the at least one cut image, and the component may include at least one of a situation, a character, a background, a camera angle, a shooting shot, a sound effect, and a dialogue.

For example, in the case, the metadata includes components (e.g., a character appearance, motion information, a background type, a camera angle, a weather situation, a time zone, etc.) of content included in the corresponding cut, and image generation parameters may be set based on the weight of each component. For example, when a user specifies a ‘character’ as a ‘boy’, specifies a ‘background’ as a ‘summer street’, and specifies a ‘composition’ as ‘close-up’, the processor 130 may generate a plurality of image candidates that match or are close to the above-described information through a generative AI model. In this case, the candidate images may be varied in a form modified by changing or deleting some of the components, or by adding new components.

In an embodiment, in operation S234, the processor 130 may display the generated plurality of candidate images via the display unit. For example, in the case, the plurality of candidate images may be configured to be output in the form of a slideshow, a thumbnail array, or a selectable carousel UI such that the user is capable of visually comparing and selecting them. For example, four candidate images generated as in FIG. 27 are listed at the bottom. Major change points such as ‘include a sound effect’, ‘emphasizing a motion’, and ‘changing color tone’ may be provided as tags or descriptions above each image.

In an embodiment, in operation S235, the processor 130 may obtain the user's selection input for one of the plurality of candidate images through the input interface. For example, the selection input may be done in various ways such as click, touch, or shortcut key input. As soon as the user makes the selection, information may be delivered such that the corresponding candidate image is capable of replacing a specified cut in the multi-cut layout.

In an embodiment, in operation S236, the processor 130 may update the multi-cut layout by replacing the at least one cut image with the selected candidate image. For example, when the user selects a candidate image including a line ‘It's late!’, the corresponding candidate image may be inserted instead of the existing identical cut image, and the locations of the associated speech bubble or effect text may also be automatically rearranged to fit the layout of the image. In this case, the locations of the speech bubble and effect text may be adjusted so as not to hinder visual concentration and reader comprehension in consideration of an eye tracking path and an object location of a cut image.

Moreover, the update process may be reflected in real time, and the user may re-examine the entire story flow based on the modified cut and may repeat additional image regeneration and layout modification tasks as needed.

In an embodiment, in operation S237, the processor 130 may provide an editing interface that allows the user to change at least one component of a cut image included in the multi-cut layout or to reconfigure the multi-cut, through the display unit 110. For example, as shown in FIGS. 28 and 29, the editing interface may be composed of various menu and operation regions, and each region may perform an independent function for intuitively and efficiently adjusting the components of the cut image.

For example, the editing interface may include a first menu region 1401, a second menu region 1402, a third menu region 1403, a 3D object display region 1404, a storyboard region 1405, and an editing option region 1406. The first menu region 1401 may be located at the top left of the editing interface and may be configured as a top-level menu structure that provides access to all editing functions. The first menu region 1401 may include functions such as characters, elements, backgrounds, cameras, templates, my page, and environment settings, and the user may select the category of the elements to be edited, through the region.

For example, when the user selects a character tab, detailed appearance modification options for the corresponding character may be displayed in the second menu region 1402. The second menu region 1402 may be a region where detailed settings items dynamically change depending on the selected top-level menu, and may include tabs such as a style, a detail, an expression, a motion, and an attribute. For example, when the user selects the expression tab, a preset that allows the user to set the character's facial expressions for various emotional expressions (e.g., happiness, surprise, anger, etc.) in detail may be displayed in the third menu region 1403.

For example, the third menu region 1403 may be a region for presenting detailed items of the second menu region in a list format, and each preset may include a function of automatically adjusting a character's visual attributes (eyes, mouth, eyebrows, etc.) based on pre-learned emotion-expression matching data. In addition to the preset, the user may individually adjust the detailed value of each element, such as the size of the pupils, the curvature of the mouth shape, and the angle of the eyebrows, by selecting a manual adjustment mode.

For example, the 3D object display region 1404 may be a region for visualizing the character of the cut image that the user is currently editing in three dimensions, and may be implemented such that the user's manipulation results may be reflected and identified in real time. The region may support operations such as rotation, enlargement, and reduction such that review of representations from various viewpoints is possible. The character may be combined with the background to be reflected in the actual cut image rendering.

For example, the storyboard region 1405 may be a configuration that visually presents the cut order and text content of a story included in a cut image such that the location and relationship of a specific cut within the entire cut is identified, or cuts are rearranged depending on the flow of the story. The user may change the cut order by selecting or dragging a specific cut through this region, and the image and text of the selected cut may be synchronized with each other such that editing operating in conjunction with the 3D object display region 1404 may be achieved.

Also, the editing interface may include the editing option region 1406 in the form of a pop-up providing editing option, as illustrated in FIG. 29. The editing option region 1406 may be activated when the user wants to share or store the completed cut image externally, and may include selection options for selecting one out of a ‘cut image’ and a ‘generated image’, an image format (PNG, JPG, etc.), resolution, whether there is a transparent background, and image merging settings. For example, when the user activates a ‘merge into one page’ option, a plurality of cut images may be configured to be merged and exported as in a single scrollable webtoon.

For example, the editing interface may accept various types of inputs in consideration of user convenience. For example, it may support not only mouse clicks, drags, and wheel scrolls, but also a touch input (mobile/tablet environments) and keyboard shortcuts, and thus the user may modify components of a cut image more intuitively and quickly.

Moreover, all operations performed in the editing interface may be automatically reflected in metadata for each cut, and may operate in conjunction with operations such as automatic placement, attribute-based recommendations, and regeneration of an image to be generated later. For example, when the user changes a character's expression, background, composition, etc., the metadata of the corresponding cut may be automatically updated, and thus the result reflecting the corresponding change value when a candidate image is generated later may be designed to be generated first.

In this way, the processor 130 may provide a multi-layered editing interface capable of accommodating various editing inputs from the user, thereby supporting the flexible detailed attribute adjustment and the reconstruction of a cut image generated through the image generating device 100. As a result, the user may customize content according to various scenarios even after the image is created, and then may receive an advanced editing experience capable of improving creative quality.

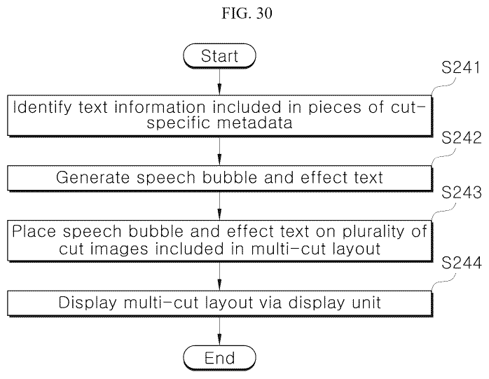

FIG. 30 is a flowchart showing a method for generating speech bubble and effect text, according to an embodiment of the present disclosure.

Referring to FIG. 30, in an embodiment, in operation S241, the processor 130 may identify text information included in the pieces of cut-specific metadata. For example, the text information may refer to text corresponding to the corresponding cut in paragraphs automatically split from a story input by a user, and each sentence may be subdivided according to punctuation, a meaning unit, and a narrative structure. The text information may be stored in a cut-dependent form as part of metadata, and may include elements such as character utterances, background descriptions, emotional expressions, onomatopoeia, and mimetic words included in the text.

For example, the processor 130 may identify the object, subject, and verb of a sentence by analyzing a sentence structure included in the text information, and may identify an utterance subject (character), an utterance target, and an emotional tone. Furthermore, it may be determined whether the style of an utterance sentence is a text type (description) or a dialogue type (utterance), and attributes such as the length of text within the sentence, emotional intensity, and whether it is a command/question may be determined. Accordingly, the determined results may be used as a standard for subsequent speech bubble creation and effective text composition.

In an embodiment, in operation S242, the processor 130 may generate a speech bubble and effect text based on the text information included in the pieces of cut-specific metadata. For example, when there is a spoken sentence in the text information, the processor 130 may recognize the corresponding sentence as a line and may generate the line as content in the form of a speech bubble. When a speech bubble is created, the tail direction and location of the speech bubble may be automatically determined in consideration of the location, gaze direction, expression, and composition information of an utterance subject character. Also, visual characteristics such as a font size, tone, and symbol processing may be automatically reflected to text within the speech bubble, and a plurality of speech bubbles may be sequentially configured when there are a plurality of conversations within the same cut.

Meanwhile, if the text information includes a word for inducing emotional expressions or sounds (e.g., “bang”, “thud”, “huh”, “wow”, etc.), the processor 130 may detect the word and may generate the detected result as effect text. The effect text may be placed on the cut image to visually emphasize it by adjusting the size, font, vibration effect, location, etc. according to the meaning and context of the word.

For example, effect text ‘Boom’ may be placed in bold Gothic font at the bottom center of the cut while having a large size; text ‘Heogeok’ may be placed in a curved shape above the character's head; and, color and outline effects may be applied together. The effect text may be automatically generated based on the cut's background contrast, situation information (urgency, tension, etc.), and motion information included in the cut's metadata in consideration of visual priority and visibility.

In an embodiment, in operation S243, the processor 130 may place the speech bubble and the effect text on a plurality of cut images included in the multi-cut layout. For example, the layout may be done in consideration of not only simple location specifications, but also complex factors such as the resolution of a cut, locations of characters and objects, whether speech bubbles overlap with each other, gaze directions, and a camera angle. For example, when a character in a cut is looking to the right, the tail of a speech bubble may be positioned to the left, and location adjustments may be made based on a blank region or an area around the character's face. When there are a plurality of characters in a cut, the speech content of each character is aligned vertically or horizontally by reflecting the order of the speech bubbles, and lines of different characters may be configured to be visually distinguished from each other by using different colors or border shapes of the speech bubbles.

Moreover, to increase connectivity with a character's motion information or emotional expression, the effect text may be placed in a location with high contrast with the background or in the center of a scene that requires emphasis. For example, in a jumping scene, effect text ‘thud’ may be placed around the character's feet, and exclamations such as ‘huh’ and ‘ah’ may be dynamically placed around the character's frightened face. The font sizes and locations of the pieces of text may be automatically adjusted based on camera shot information (e.g., close-up, full shot, etc.) included in a cut's metadata, and the spacing between a speech bubble and text may also be automatically adjusted to ensure a natural connection according to a story flow.

In an embodiment, in operation S244, the processor 130 may display the multi-cut layout via a display unit. For example, the processor 130 may visually provide the entire multi-cut layout, in which the speech bubble and effect text are placed, in an integrated layout through the display unit 110. The multi-cut layout may be determined by the user's selection from a vertical webtoon format or a page-type configuration; each cut may be aligned vertically or in a grid structure; and, the spacing between cuts and the flow of speech bubble connections may be implemented to be clearly visualized. The user may intuitively identify the flow of the overall story, the order of dialogue delivery, the timing of effect text, etc. through the displayed multi-cut layout, and may request modifications to individual cuts again as necessary.

In addition, in the display process, the processor 130 may automatically determine whether the speech bubble and effect text of each cut are appropriately placed, may review whether the text is placed so as not to cover an image element, and may perform a post-processing algorithm that automatically re-adjusts the location or adjusts a text style when detecting duplication between pieces of text or an decrease in readability.

In this way, the processor 130 may recognize text information from pieces of cut-specific metadata, and may automatically generate and places speech bubbles and effect text that match the story flow based on the text information, thereby automating the composition of authoring elements in a process of creating story-based image content, and improving work productivity. Besides, automatically placed text may be intuitively modified according to the user's editing request, thereby increasing creative freedom and ensuring consistency and quality for various scenes and dialogue expressions.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

According to an embodiment of the present disclosure, the consistency and accuracy of the image generation results may be secured by accurately reflecting a 3D object directly selected by a user and an attribute value of the corresponding object to a generative AI.

Moreover, according to an embodiment of the present disclosure, the same attribute values may produce consistent visual effects in various compositions by automatically adjusting weights of attribute values based on cut attributes (a shooting shot type, an angle, a distance, an occupancy ratio, etc.).

Furthermore, according to an embodiment of the present disclosure, generative AI results may more precisely match user intent by automatically generating predefined weights and prompt combinations depending on visual attributes such as expressions, motions, and hairstyles set by a user.

Besides, according to an embodiment of the present disclosure, the user may visually identify and modify the result in advance, by providing a preview screen with the expected result of an image to which the corresponding attribute value is reflected when an attribute value is specified, in real time.

In addition, according to an embodiment of the present disclosure, even non-experts may obtain high-quality results without separate settings, by automatically estimating and correcting the appropriate attribute value based on information such as the cut attribute and screen occupancy ratio even when the attribute value is not specified.

Also, according to an embodiment of the present disclosure, even in an image where a plurality of 3D objects appear simultaneously, the weight of each attribute value may be adjusted according to a screen proportion occupied by each object, thereby enabling accurate and harmonious image expression even in complex scenes.

Moreover, according to an embodiment of the present disclosure, the completeness of the initial generation result may be improved without subsequent modification by assigning weights to attribute values in a pre-image generation stage, generating a prompt reflecting the corresponding information, and inputting the prompt into a model.

Furthermore, according to an embodiment of the present disclosure, a storyboard may be automatically produced without manual work by automatically analyzing a story in text form to divide it into cut units, and by automatically extracting content information such as characters, backgrounds, and objects from each cut.

Besides, according to an embodiment of the present disclosure, images corresponding to each cut may be automatically generated by using generative AI based on the extracted content information, and thus an image set with a consistent tone and atmosphere may be implemented without a creator's drawing.

In addition, according to an embodiment of the present disclosure, editing efficiency may be dramatically improved by configuring metadata (e.g., character information, motion information, or background settings) together with automatically generated images for each cut to directly utilize the metadata for editing layout work such as cut placement, speech bubbles, and effect text placement.

Also, according to an embodiment of the present disclosure, user-customized content may be produced by presenting a plurality of alternative image candidates for each automatically generated cut image at the request of a user and configuring the user to select the image that the user wants among the alternative image candidates.

Moreover, according to an embodiment of the present disclosure, the completeness of the content may be increased by automatically generating speech bubbles and effect text based on text information included in the metadata of a cut and placing them in an appropriate location for each cut image.

Furthermore, according to an embodiment of the present disclosure, freedom of modification after production may be secured by providing an interface that allows the user to directly edit images or components on the generated multi-cut layout.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. An image generating device comprising:
a display unit configured to provide an input interface for receiving selection information of at least one 3D object for image generation and attribute value designation information of the 3D object;
a memory configured to store at least one process related to an operation of generating an image by using the 3D object and a generative AI model; and
a processor configured to perform an operation according to the process,
wherein the processor is configured to:
obtain the 3D object selected through the input interface, and an attribute value of the selected 3D object;
obtain cut attribute information through the input interface;
correct a weight of the attribute value based on the cut attribute information;
generate a prompt based on the 3D object and an attribute value reflecting the corrected weight; and
generate a final image by inputting the generated prompt into the generative AI model.

2. The image generating device of claim 1, wherein the processor is configured to:
generate a temporary prompt based on the 3D object and the attribute value; and
change the temporary prompt to the prompt based on the 3D object and the attribute value reflecting the corrected weight.

3. The image generating device of claim 2, wherein the cut attribute information includes at least one of a type of shooting shot, a camera angle, a distance between the 3D object and a camera, a location of the 3D object, and an expected screen occupancy ratio occupied by the 3D object in the image.

4. The image generating device of claim 3, wherein the processor is configured to:
correct the weight of the attribute value based on the type of the shooting shot.

5. The image generating device of claim 3, wherein the processor is configured to:
identify the expected screen occupancy ratio that the 3D object occupies in the image;
compare the expected screen occupancy ratio with a preset first threshold value and a preset second threshold value;
when the comparison result indicates that the expected screen occupancy ratio is less than the first threshold value, perform the correction to increase the weight of the attribute value; and
when the comparison result indicates that the expected screen occupancy ratio exceeds the second threshold value, perform the correction to decrease the weight of the attribute value.

6. The image generating device of claim 5, wherein the attribute value includes at least one of expression intensity, a size or speed of a motion, hair color, clothing color, or sharpness of a pattern of the 3D object.

7. The image generating device of claim 6, wherein the processor is configured to:
when detecting an input through which a user specifies the attribute value through the input interface, provide a preview of an expected result to which the attribute value is applied.

8. The image generating device of claim 7, wherein the processor is configured to:
when detecting an input through which the user selects a predefined visual option, automatically generate an associated prompt and an attribute value corresponding to the visual option.

9. An image generating device comprising:
a display unit configured to provide an input interface for obtaining a story;
a memory configured to store at least one process related to an operation of generating a story image by using the story; and
a processor configured to perform an operation according to the process,
wherein the processor is configured to:
obtain the story through the input interface;
analyze the obtained story to split the story into a plurality of cuts;
extract content information based on text included in each of the plurality of cuts;
generate a plurality of initial images corresponding to the plurality of cuts based on the extracted content information;
generate pieces of cut-specific metadata based on the content information and the plurality of initial images;
generate a multi-cut layout based on the generated pieces of cut-specific metadata and the plurality of initial images;
display the multi-cut layout via the input interface;
obtain an image regeneration request for at least one cut image included in the multi-cut layout from a user through the input interface; and
generate a plurality of candidate images for the at least one cut image based on metadata of a cut corresponding to the at least one cut image in response to the image regeneration request.

10. The image generating device of claim 9, wherein the processor is configured to:
display the generated plurality of candidate images through the display unit;
obtain a selection input of the user for one candidate image of the plurality of candidate images through the input interface; and
update the multi-cut layout by replacing the at least one cut image with the selected candidate image.

11. The image generating device of claim 10, wherein the extracted content information includes at least one of character information, background information, and object information.

12. The image generating device of claim 11, wherein the pieces of cut-specific metadata includes at least one of character information, background information, object information, motion information, camera angle information, shooting shot information, time information, situation information, and text information.

13. The image generating device of claim 12, wherein the processor is configured to:
generate a speech bubble and effect text based on the text information included in the pieces of cut-specific metadata; and
place the speech bubble and the effect text on a plurality of cut images included in the multi-cut layout.

14. The image generating device of claim 13, wherein the processor is configured to:
generate the plurality of candidate images by using at least one of changing, deleting, or adding a component included in the at least one cut image, and
wherein the component includes at least one of a situation, a character, a background, a camera angle, a shooting shot, a sound effect, and a line.

15. The image generating device of claim 14, wherein the processor is configured to:
generate the multi-cut layout to minimize interference between cuts in consideration of a special symbol, a punctuation mark, a scene transition keyword, a time transition keyword, a location transition keyword, a size of each cut image, spacing between cuts, and locations of the speech bubble and the effect text, which are included in text of the story.

16. The image generating device of claim 15, wherein the processor is configured to:
further provide an editing interface that allows the user to change at least one component of a cut image included in the multi-cut layout or to reconfigure a multi-cut, through the display unit.
